(19) United States
(12) Patent Application Publication
(10) Pub. No.: US 2026/0168072 A1
(43) Pub. Date: Jun. 18, 2026

(54) PRINTABLE STEEL WITH HIGH ELEVATED TEMPERATURE STRENGTH, THERMAL CONDUCTIVITY, AND RESISTANCE TO SOFTENING

(71) Applicant: UT-Battelle, LLC, Oak Ridge, TN (US)

(72) Inventors: Dean T. Pierce, Knoxville, TN (US); Nana Adomako, Knoxville, TN (US); Peeyush Nandwana, Knoxville, TN (US); Rishi R. Pillai, Knoxville, TN (US); Thomas Feldhausen, Knoxville, TN (US); Jonathan D. Poplawsky, Knoxville, TN (US); Kinga A. Unocic, Knoxville, TN (US); Rangasayee Kannan, Knoxville, TN (US); Michael J. Thompson, knoxville, TN (US); Sumit Bahl, Knoxville, TN (US); Hsin Wang, Knoxville, TN (US); Amir Ziabari, Knoxville, TN (US); James A. Haynes, Knoxville, TN (US)

(21) Appl. No.: 19/420,311

(22) Filed: Dec. 15, 2025

Related U.S. Application Data
(60) Provisional application No. 63/733,554, filed on Dec. 13, 2024.
(60) Provisional application No. 63/907,413, filed on Oct. 29, 2025.

(51) Int. Cl. C22C 38/44; B22F 10/28; B22F 10/64; B33Y 10/00; B33Y 70/00; B33Y 80/00; C22C 38/00; C22C 38/02; C22C 38/04; C22C 38/06; C22C 38/42; C22C 38/46; C22C 38/48; C22C 38/50; C22C 38/52; C22C 38/54

(52) U.S. Cl. CPC C22C 38/44; B22F 10/28; B22F 10/64; C22C 38/001; C22C 38/02; C22C 38/04; C22C 38/06; C22C 38/42; C22C 38/46; C22C 38/48; C22C 38/50; C22C 38/52; C22C 38/54; B22F 2301/35; B33Y 10/00; B33Y 70/00; B33Y 80/00

(57) ABSTRACT

A printable steel alloy can comprise 1.75 to 5 Cu; 1.9 to 8 Mo; 0 to 4.25 Ni; 0 to 1 Mn; 0 to 0.1 C; 0 to 6 Cr; 0 to 2.1 Si; 0 to 1.6 Ti; 0 to 1 Nb; 0 to 7 W; 0 to 6 Co; 0 to 1 Al; 0 to 0.1 N; 0 to 0.04 S; 0 to 0.005 B; 0 to 0.1 V; and, balance Fe. The alloy can have a strength factor (SF) of 23≤SF≤50, an austenite reversion factor (ARF) of 50≤ARF≤100, a heat transfer factor (HTF) of 4.9≤HTF≤9, a high temperature austenite stability factor (HTASF) of −15≤HTASF≤40, and/or a NiCoTi factor (NiCoTiF) of 0≤NiCoTiF≤10.

### CROSS-REFERENCE TO RELATED APPLICATIONS

This application claims priority to U.S. 63/733,554, filed on Dec. 13, 2024 entitled “PRINTABLE STEEL WITH GOOD BALANCE OF HIGH ELEVATED TEMPERATURE STRENGTH, THERMAL CONDUCTIVITY, AND OXIDATION RESISTANCE”, and to U.S. 63/907,413, filed on Oct. 29, 2025 entitled “PRINTABLE STEEL WITH GOOD BALANCE OF HIGH ELEVATED TEMPERATURE STRENGTH, THERMAL CONDUCTIVITY, AND OXIDATION RESISTANCE” the entire disclosure of which incorporated herein by reference.

### STATEMENT REGARDING FEDERALLY SPONSORED RESEARCH AND DEVELOPMENT

This invention was made with government support under Contract No. DE-AC05-00OR22725 awarded by the United States Department of Energy. The government has certain rights in this invention.

### FIELD OF THE INVENTION

The present invention relates to steel alloys, and more particularly printable steel alloys.

### BACKGROUND OF THE INVENTION

High pressure die-casting (HPDC) and metal stamping are critical manufacturing processes for making parts for the automotive, aerospace, consumer electronics, and other industries. Dies and die inserts used for these processes are typically manufactured from standard wrought tool steels using conventional processes like machining, welding, drilling, and heat treating to achieve the final die and/or insert geometries, which can be large and complex. These processes can result in long lead times and significant expense. This reduces the responsiveness and efficiency of manufacturing lines. Additive Manufacturing (AM) processes such as Laser Powder Bed Fusion (LPBF), blown powder-direct energy deposition (BP-DED), and wire arc DED (WA-DED) have high potential for manufacturing low volume, complex tool and die components, particularly those with intricate internal cooling channels, in relatively short periods of time. However, most conventional martensitic tool steels, such as H13, H10, DIN 1.2367, and DH31-EX (compositions listed in Table 1) have specified ranges of C that generally fall within 0.3 to 0.45 wt. %. This level of carbon results in high hardness, often near or exceeding 50 HRC, after cooling at a rate sufficiently high enough to result in martensitic transformation. The high hardness causes the microstructure to be brittle and is one factor causing these conventional martensitic tool steels to have high susceptibility to cracking and poor printability for the above-mentioned AM processes under typical printing conditions.

TABLE 1
Compositions of typical commercial medium C tool steels H10, H13, DIN 1.2367, and DH31-EX, as
well as maraging steels M200, M250, M300, M350, Mar-50 Co-free, Mar-60, Stellar TS700 in wt.
%. Compositions include typical ranges, nominal, and/or measured from heats of the material.

| Alloy Grade | Ni | Mn | C | Cr | Si | V | Mo | Cu | W | Al |
|---|---|---|---|---|---|---|---|---|---|---|
| H10 Modified | — | 0.25-0.7 | 0.35-0.45 | 3.0-3.8 | 0.80-1.20 | 0.25-0.75 | 2.0-3.0 | — | — | — |
| range | | | | | | | | | | |
| H10 modified | 0.12 | 0.36 | 0.361 | 3.55 | 0.94 | 0.42 | 2.43 | 0.041 | 0.049 | — |
| measured | | | | | | | | | | |
| H13 range | ≤0.30 | 0.20-0.50 | 0.32-0.45 | 4.75-5.50 | 0.80-1.20 | 0.80-1.20 | 1.10-1.75 | ≤0.25 | — | — |
| H13 measured | 0.16 | 0.39 | 0.4 | 5.18 | 1.07 | 0.96 | 1.49 | 0.076 | 0.046 | — |
| DIN 1.2367 | — | 0.30-0.60 | 0.35-0.40 | 4.70-5.20 | 0.3-0.5 | 0.40-0.70 | 2.70-3.30 | — | — | — |
| Range | | | | | | | | | | |
| 1.2367 Measured | 0.22 | 0.39 | 0.377 | 5.13 | 0.36 | 0.42 | 2.75 | 0.12 | 0.016 | — |
| DH31-EX Range | — | 0.1-1.2 | 0.32-0.40 | 4.7-5.85 | 0.10-0.50 | 0.40-0.70 | 2.00-3.30 | — | — | — |
| DH31-EX | 0.063 | 1.05 | 0.353 | 5.58 | 0.28 | 0.48 | 2.30 | 0.048 | 0.013 | — |
| Measured | | | | | | | | | | |
| 422C Measured | 0.79 | 0.78 | 0.23 | 12.09 | 0.36 | 0.22 | 1.08 | 0.08 | 0.96 | — |
| M200 Range | 17-19 | ≤0.12 | ≤0.03 | — | ≤0.12 | — | 3-3.5 | — | — | 0.05-0.15 |
| M250 Range | 17-19 | ≤0.12 | ≤0.03 | — | ≤0.12 | — | 4.6-5.1 | — | — | 0.05-0.15 |
| M300 Range | 17-19 | ≤0.12 | ≤0.03 | — | ≤0.12 | — | 4.6-5.2 | — | — | 0.05-0.15 |
| M300 Measured | 18.57 | 0.02 | <0.01 | 0.06 | 0.02 | — | 4.86 | 0.01 | — | 0.12 |
| M350 Range | 17-19 | ≤0.1 | ≤0.03 | — | ≤0.1 | — | 3.5-4.0 | — | — | 0.1-0.2 |
| Mar-50-Co Free | 9.5 | ≤0.5 | ≤0.06 | 4 | ≤0.5 | — | 4.5 | — | — | ≤0.3 |
| Nominal | | | | | | | | | | |
| Mar-60 (ASTM/ | 13.0 | ≤0.1 | ≤0.03 | ≤0.3 | ≤0.1 | — | 10.0 | — | — | ≤0.01 |
| AlSI 13Ni400) | | | | | | | | | | |
| Nominal | | | | | | | | | | |
| Stellar TS700 | 1.5-3 | — | 0-0.05 | 4-5.75 | — | — | 7-9 | — | — | — |
| Range | | | | | | | | | | |
| Stellar TS700 | 2.25 | — | 0.025 | 4.625 | — | — | 8 | — | — | — |
| Nominal | | | | | | | | | | |

| Alloy Grade | N | S | P | Ti | Co | Nb | Ni + Co | Ni + Co + Ti | Fe |
|---|---|---|---|---|---|---|---|---|---|
| H10 Modified | — | ≤0.03 | ≤0.03 | — | 0-2 | — | 0-2 | 0-2 | Bal. |
| range | | | | | | | | | |
| H10 modified | 0.009 | 0.002 | 0.021 | 0.001 | 1.62 | 0.041 | 1.74 | 1.741 | Bal. |
| measured | | | | | | | | | |
| H13 range | ≤0.1 | ≤0.03 | ≤0.03 | — | — | — | ≤0.30 | — | Bal. |
| H13 measured | 0.019 | 0.003 | 0.01 | 0.0024 | 0.015 | <0.002 | 0.175 | 0.1774 | Bal. |
| DIN 1.2367 | — | ≤0.03 | ≤0.03 | — | — | — | — | — | Bal. |
| Range | | | | | | | | | |
| 1.2367 Measured | 0.012 | 0.011 | 0.018 | 0.0008 | 0.017 | 0.0034 | 0.237 | 0.2378 | Bal. |
| DH31-EX Range | — | ≤0.003 | <0.002 | | | | | — | Bal. |
| DH31-EX | 0.009 | 0.002 | 0.0028 | 0.0009 | 0.041 | 0.0024 | 0.104 | 0.1049 | Bal. |
| Measured | | | | | | | | | |
| 422C Measured | 0.048 | 0.006 | 0.019 | — | — | — | | | Bal. |
| M200 Range | — | ≤0.01 | ≤0.01 | 0.15-0.25 | 8.0-9.0 | — | 25-28 | 25.15-28.25 | Bal |
| M250 Range | — | ≤0.01 | ≤0.01 | 0.3-0.5 | 7.0-8.5 | — | 24-27.5 | 24.3-28 | Bal. |
| M300 Range | — | ≤0.01 | ≤0.01 | 0.5-0.8 | 8.0-9.5 | — | 26-28.8 | 26.5-29.6 | Bal. |
| M300 Measured | — | <0.001 | 0.006 | 0.63 | 9.26 | — | 27.83 | 28.46 | Bal. |
| M350 Range | — | ≤0.005 | ≤0.005 | 1.3-1.6 | 11.5-12.5 | — | 28.5-30.5 | 29.8-32.1 | Bal. |
| Mar-50-Co Free | — | ≤0.03 | ≤0.03 | ≤1.0 | ≤0.1 | — | 9.5 | 10.5 | Bal. |
| Nominal | | | | | | | | | |
| Mar-60 (ASTM/ | ≤0.1 | ≤0.01 | ≤0.01 | 0.2 | 15.0 | — | 28 | 28.2 | Bal. |
| AlSI 13Ni400) | | | | | | | | | |
| Nominal | | | | | | | | | |
| Stellar TS700 | — | — | — | — | 10-13 | — | 8.5-16 | 8.5-12 | Bal. |
| Range | | | | | | | | | |
| Stellar TS700 | — | — | — | — | 11.5 | — | 13.8 | 13.8 | |
| Nominal | | | | | | | | | |

In contrast, maraging steels, which typically have C levels <0.06 wt. %, form a soft, highly ductile matrix upon cooling, which resists cracking and makes them highly printable by AM. In addition to low C content, maraging steels may contain approximately 1 to 19 wt. % Ni and up to approximately 15 wt. % Co, depending on the grade. The total Ni+Co content of these steels typically ranges from approximately 8 to 31 wt. % depending on the grade. Mo additions of 3 to 10 wt. % are typically added for strengthening, and Ti may also be added for strengthening in amounts up to approximately 1.6 wt. % depending on the grade. Cr may be added for environmental resistance (oxidation and corrosion). Table 1 lists the compositions of some commercially available maraging steels, including grades M200, M250, M300, and M350, Mar-50 Co-free, Mar-60, and Stellar TS700. Maraging steels are typically strengthened to hardnesses greater than approximately 40 HRC by the precipitation of fine intermetallic phases enriched in Fe, Ni, Mo, and Ti during subsequent age-hardening treatments at temperatures which typically range from 400-600° C. for times of about 2-6 hours. Maraging steels are predominately used in applications where the service temperatures are near ambient temperature or lower.

However, maraging steels are sometimes used to print steel dies and inserts with complex geometries and/or internal cooling channels for high temperature applications like HPDC, hot stamping, or metal forming due to their excellent printability. Certain compositional aspects of maraging steels cause them to have inferior performance and reduced durability and longevity compared to conventional medium C tool steels in the aforementioned applications, including but not limited to the following:

The Ae1 temperature, which is the temperature at equilibrium where upon heating, the austenite phase begins to form in steel, is excessively lowered by the large additions of Ni that are often present in maraging steels. An excessively low Ae1 transformation temperature causes steel to undergo undesirable phase transformations, such as reversion to austenite, when exposed to extended periods of time at typical die service temperatures in HPDC or other high temperature applications where a portion of the steel experiences temperatures greater than the Ae1 temperature. For instance, maraging steel grades M200, M250, M300, M350, MAR-50 Co-Free, and Mar-60 contain Ni contents in the range of 9-19 wt. %, which excessively lowers the Ae1 temperature. In addition to lowering the Ae1 temperature, increasing Ni content can also cause larger amounts of austenite to be stable. For instance, the Ae1 temperature and equilibrium amount of austenite in volume percent is predicted at 500° C. and shown in Table 2 for martensitic tool steel H13 along with commercially available maraging steels M300, Mar-50 Co-free, Mar-60, and Stellar TS 700. The calculations were performed using Thermo-Calc 2024a with the TCFe13 database. The nominal or measured compositions given in Table 1 were used for the calculations. The austenite content of TS 700, Mar-50 Co-Free, Mar-60, and M300 increases from 0, 14.6, 21.8, and 36.4 vol. %, respectively, which corresponds to their approximate Ni contents of 2.25, 9.5, 13, and 18.57. It is desirable for the steel to have a predicted austenite content of 5 vol. % or below at 500° C. for service in dies for elevated temperature service applications like high pressure aluminum die-casting.

TABLE 2
Ae1 temperature of commercial alloys H13, M300,
Mar-50 Co-free, Mar-60, and Stellar TS 700 and
equilibrium austenite vol. % at 500° C.

| | Ae1 | Austenite |
|---|---|---|
| | Temperature | Content (vol. %) |
| Alloy | (° C.) | at 500° C. |
| H13 | 840 | 0 (Below Ae1) |
| M300 | 404 | 36.4 |
| Mar-50 Co-Free | 394 | 14.6 |
| Mar-60 (ASTM/ | 430 | 21.8 |
| AISI 13Ni400) | | |
| Nominal | | |
| TS 700 | 752 | 0 (Below Ae1) |

b) Typical maraging steels such as those in Table 1 contain relatively large amounts of Ni, Co, and Ti (8.5-32 wt. % Ni+Co+Ti), which have a strong tendency to form intermetallic compounds with Al. This increases the tendency for the Al alloy being casted to solder and stick to the die surface, form brittle intermetallics, and result in damage to the die during repeated die casting cycles.

c) Large addition of Ni greater than approximately 4.25 wt. % can contribute to relatively low thermal conductivity, which can increase the thermal stresses on dies during HPDC, thereby reducing durability. Low thermal conductivity can also increase cycle times as dies with lower thermal conductivity will cool more slowly to the specified temperature at which the next die-casting cycle can be initiated.

d) Ti can reduce machinability. Ti is highly reactive with oxygen and may react with oxygen during powder atomization and/or printing, which can degrade mechanical properties.

Additionally, Co is often used in maraging steels as an effective way to improve the age hardening response. However, Co has been linked to significant health concerns when chronic exposure and/or inhalation occurs. Atomization and/or printing of steels containing Co can increase the risk of exposure.

Based on these challenges with typical maraging steels, there exists a need for a new printable steel that also forms a soft and ductile martensitic phase upon cooling that can be age hardened to high strengths, but that has relatively low Ni, Co, and Ti content, a sufficiently high Ae1 temperature to improve phase stability in service, and good thermal conductivity to enable durability and reduced cycling times.

### SUMMARY OF THE INVENTION

A printable steel alloy, comprises, consists essentially of, or consists of, in weight percent based on the total weight of the alloy: 1.75 to 5 Cu; 1.9 to 8 Mo; 0 to 4.25 Ni; 0 to 1 Mn; 0 to 0.1 C; 0 to 6 Cr; 0 to 2.1 Si; 0 to 1.6 Ti; 0 to 1 Nb; 0 to 7 W; 0 to 6 Co; 0 to 1 Al; 0 to 0.1 N; 0 to 0.04 S; 0 to 0.005 B; 0 to 0.1 V; and, balance Fe.

The printable steel alloy can have a strength factor (SF) that is defined by the equation:

$$S F = - 15.1 - 0.39 {Ni}_{wt . \%} + 0.95 {Mn}_{wt . \%} + 75.2 {C}_{wt . \%} + 2.29 {Cr}_{wt . \%} + 11.6 {Si}_{wt . \%} + 5.93 {Mo}_{wt . \%} + 2.91 {Cu}_{wt . \%} + 10.3 {Ti}_{wt . \%} + 26.8 {Nb}_{wt . \%} + 2.54 {W}_{wt . \%} + 0.78 {Co}_{wt . \%} + 9. {Al}_{wt . \%} + 0.48 ( {Mo}_{wt . \%} - 4.58 ) ( {Mo}_{wt . \%} - 4.58 ) - 2.56 ( {Si}_{wt . \%} - 0.65 ) ( {Si}_{wt . \%} - 0.65 ) - 37.1 ( {Nb}_{wt . \%} - 0.09 ) ( {Nb}_{wt . \%} - 0.09 ) + 2.67 ( {Mo}_{wt . \%} - 4.58 ) ( {Si}_{wt . \%} - 0.65 ) + 4. ( {Ni}_{wt . \%} - 2.95 ) ( {Ti}_{wt . \%} - 0.12 ) + 0.008 ( {Ni}_{wt . \%} - 2.95 ) ( {Mo}_{wt . \%} - 4.58 ) ;$$

$$and wherein 23 \leq S F \leq 50 .$$

The printable steel alloy can have an austenite reversion factor (ARF) is defined by the equation:

$$A R F = 102 - 5.8 {Ni}_{wt . \%} - 7.4 {Mn}_{wt . \%} - 0.9 {Cr}_{wt . \%} + 2. {Si}_{wt . \%} + 0.04 {Mo}_{wt . \%} - 1.1 {Cu}_{wt . \%} + 0.6 {Co}_{wt . \%} + 3.1 {Al}_{wt . \%} ;$$

$$and wherein 50 \leq A R F \leq 100.$$

$$The A R F can alternatively be 60 \leq A R F \leq 100.$$

The printable steel alloy can have a heat transfer factor (HTF) that is defined by the equation:

$$H T F = 7.1 - 0.5 {Mn}_{wt . \%} - 0.32 {Cr}_{wt . \%} - 0.43 {Si}_{wt . \%} - 0.15 ( {Mo}_{wt . \%} + {W}_{wt . \%} + {Nb}_{wt . \%} ) - 0.03 {Co}_{wt . \%} - 0.43 {Al}_{wt . \%} + 3.09 Exp ( - 0 \text{.28} {Ni}_{wt . \%} )$$

$$and wherein 4.9 \leq H T F \leq 9.$$

The printable steel alloy can have a high temperature austenite stability factor (HTASF) that is defined by the equation:

$$H T A S F = 12 {Ni}_{wt . \%} + 10.2 {Mn}_{wt . \%} + 320 {C}_{wt . \%} - 0.4 {( {Cr}_{wt . \%} )}^{2} + 3.2 {Cr}_{wt . \%} - 5.7 {Si}_{wt . \%} - 9.4 {Mo}_{wt . \%} + 5.7 {Cu}_{wt . \%} - 13 {Ti}_{wt . \%} - 14.8 {Nb}_{wt . \%} - 1.2 {W}_{wt . \%} + 3.7 {Co}_{wt . \%} - 29.3 {Al}_{wt . \%} - 97.3 {V}_{wt . \%} - 0.46 ;$$

$$and wherein \text{-15} \leq H T A S F \leq 40.$$

The alloy can comprise a NiCoTi factor (NiCoTiF) that is defined as

$$NiCoTiF = {Ni}_{wt . \%} + {Co}_{wt . \%} + {Ti}_{wt . \%} ; wherein 0 \leq NiCo TiF \leq 10 .$$

The printable steel alloy can comprise:
a strength factor (SF) is defined by the equation:

$$S F = - 1 5.1 - 0.39 {Ni}_{wt . \%} + 0.95 {Mn}_{wt . \%} + 75.2 {C}_{wt . \%} + 2.29 {Cr}_{wt . \%} + 11.6 {Si}_{wt . \%} + 5.93 {Mo}_{wt . \%} + 2.91 {Cu}_{wt . \%} + 10.3 {Ti}_{wt . \%} + 26.8 {Nb}_{wt . \%} + 2.54 {W}_{wt . \%} + 0.78 {Co}_{wt . \%} + 9. {Al}_{wt . \%} + 0.48 ( {Mo}_{wt . \%} - 4.58 ) ( {Mo}_{wt . \%} - 4.58 ) - 2.56 ( {Si}_{wt . \%} - 0.65 ) ( {Si}_{wt . \%} - 0.65 ) - 37.1 ( {Nb}_{wt . \%} - 0.09 ) ( {Nb}_{wt . \%} - 0.09 ) + 2.67 ( {Mo}_{wt . \%} - 4.58 ) ( {Si}_{wt . \%} - 0.65 ) + 4. ( {Ni}_{wt . \%} - 2.95 ) ( {Ti}_{wt . \%} - 0.12 ) + 0.008 ( {Ni}_{wt . \%} - 2.95 ) ( {Mo}_{wt . \%} - 4.58 ) ;$$

$$wherein 23 \leq S F \leq 50 ;$$

an austenite reversion factor (ARF) that is defined by the equation:

$$A R F = 102 - 5.8 {Ni}_{wt . \%} - 7.4 {Mn}_{wt . \%} - 0.9 {Cr}_{wt . \%} + 2. {Si}_{wt . \%} + 0.04 {Mo}_{wt . \%} - 1.1 {Cu}_{wt . \%} + 0.6 {Co}_{wt . \%} + 3.1 {Al}_{wt . \%} ; wherein 50 \leq A R F \leq 100 ;$$

a heat transfer factor (HTF) that is defined by the equation:

$$H T F = 7.1 - 0.5 {Mn}_{wt . \%} - 0.32 {Cr}_{wt . \%} - 0.43 {Si}_{wt . \%} - 0.15 ( {Mo}_{wt . \%} + {W}_{wt . \%} + {Nb}_{wt . \%} ) - 0.03 {Co}_{wt . \%} - 0.43 {Al}_{wt . \%} + 3.09 Exp ( - 0 \text{.28} {Ni}_{wt . \%} ) ; wherein 4.9 \leq H T F \leq 9 ; and$$

a high temperature austenite stability factor (HTASF) that is defined by the equation:

$$H T A S F = 12 {Ni}_{wt . \%} + 10.2 {Mn}_{wt . \%} + 320 {C}_{wt . \%} - 0.4 ( {Cr}_{wt . \%} ) 2 + 3.2 {Cr}_{wt . \%} - 5.7 {Si}_{wt . \%} - 9.4 {Mo}_{wt . \%} + 5.7 {Cu}_{wt . \%} - 13 {Ti}_{wt . \%} - 14.8 {Nb}_{wt . \%} - 1.2 {W}_{wt . \%} + 3.7 {Co}_{wt . \%} - 29.3 {Al}_{wt . \%} - 97.3 {V}_{wt . \%} - 0.46 ; wherein \text{-15} \leq H T A S F \leq 40.$$

The printable steel alloy can have an as-quenched hardness that is equal to or less than 37 HRC after solution treatment at 1065° C. for 1 h and water quenching.

A method for printing an article with a steel alloy can comprise the steps of:
providing a steel alloy feedstock, the feedstock comprising, in weight percent based on the total weight of the alloy: 1.75 to 5 Cu; 1.9 to 8 Mo; 0 to 4.25 Ni; 0 to 1 Mn; 0 to 0.1 C; 0 to 6 Cr; 0 to 2.1 Si; 0 to 1.6 Ti; 0 to 1 Nb; 0 to 7 W; 0 to 6 Co; 0 to 1 Al; 0 to 0.1 N; 0 to 0.04 S; 0 to 0.005 B; 0 to 0.1 V; balance Fe;
   wherein the feedstock is in powder or wire form; and,
   printing the article with the feedstock.

The printable steel alloy used in the method can have a strength factor (SF) that is defined by the equation:

$$S F = - 1 5.1 - 0.39 {Ni}_{wt . \%} + 0.95 {Mn}_{wt . \%} + 75.2 {C}_{wt . \%} + 2.29 {Cr}_{wt . \%} + 11.6 {Si}_{wt . \%} + 5.93 {Mo}_{wt . \%} + 2.91 {Cu}_{wt . \%} + 10.3 {Ti}_{wt . \%} + 26.8 {Nb}_{wt . \%} + 2.54 {W}_{wt . \%} + 0.78 {Co}_{wt . \%} + 9. {Al}_{wt . \%} + 0.48 ( {Mo}_{wt . \%} - 4.58 ) ( {Mo}_{wt . \%} - 4.58 ) - 2.56 ( {Si}_{wt . \%} - 0.65 ) ( {Si}_{wt . \%} - 0.65 ) - 37.1 ( {Nb}_{wt . \%} - 0.09 ) ( {Nb}_{wt . \%} - 0.09 ) + 2.67 ( {Mo}_{wt . \%} - 4.58 ) ( {Si}_{wt . \%} - 0.65 ) + 4. ( {Ni}_{wt . \%} - 2.95 ) ( {Ti}_{wt . \%} - 0.12 ) + 0.008 ( {Ni}_{wt . \%} - 2.95 ) ( {Mo}_{wt . \%} - 4.58 ) ; wherein 23 \leq S F \leq 50.$$

The printable steel alloy used in the method can have an austenite reversion factor (ARF) is defined by the equation:

$$A R F = 102 - 5.8 {Ni}_{wt . \%} - 7.4 {Mn}_{wt . \%} - 0.9 {Cr}_{wt . \%} + 2. {Si}_{wt . \%} + 0.04 {Mo}_{wt . \%} - 1.1 {Cu}_{wt . \%} + 0.6 {Co}_{wt . \%} + 3.1 {Al}_{wt . \%} ; wherein 50 \leq A R F \leq 100.$$

$$The A R F can be 60 \leq A R F \leq 100.$$

The printable steel alloy used in the method can have a heat transfer factor (HTF) that is defined by the equation:

$$H T F = 7.1 - 0.5 {Mn}_{wt . \%} - 0.32 {Cr}_{wt . \%} - 0.43 {Si}_{wt . \%} - 0.15 ( {Mo}_{wt . \%} + {W}_{wt . \%} + {Nb}_{wt . \%} ) - 0.03 {Co}_{wt . \%} - 0.43 {Al}_{wt . \%} + 3.09 Exp ( - 0 \text{.28} {Ni}_{wt . \%} ) ; wherein 4.9 \leq H T F \leq 9.$$

The printable steel alloy used in the method can have a high temperature austenite stability factor (HTASF) that is defined by the equation:

$$H T A S F = 12 {Ni}_{wt . \%} + 10.2 {Mn}_{wt . \%} + 320 {C}_{wt . \%} - 0.4 {( {Cr}_{wt . \%} )}^{2} + 3.2 {Cr}_{wt . \%} - 5.7 {Si}_{wt . \%} - 9.4 {Mo}_{wt . \%} + 5.7 {Cu}_{wt . \%} - 13 {Ti}_{wt . \%} - 14.8 {Nb}_{wt . \%} - 1.2 {W}_{wt . \%} + 3.7 {Co}_{wt . \%} - 29.3 {Al}_{wt . \%} - 97.3 {V}_{wt . \%} - 0.46 ; wherein \text{-15} \leq H T A S F \leq 40.$$

The printable steel alloy used in the method can The alloy can comprise a NiCoTi factor (NiCoTiF) that is defined as

$$NiCoTiF = {Ni}_{wt . \%} + {Co}_{wt . \%} + {Ti}_{wt . \%} ; wherein 0 \leq NiCoTiF \leq 10.$$

The printable steel alloy used in the method can comprise:
a strength factor (SF) that is defined by the equation:

$$S F = - 1 5.1 - 0.39 {Ni}_{wt . \%} + 0.95 {Mn}_{wt . \%} + 75.2 {C}_{wt . \%} + 2.29 {Cr}_{wt . \%} + 11.6 {Si}_{wt . \%} + 5.93 {Mo}_{wt . \%} + 2.91 {Cu}_{wt . \%} + 10.3 {Ti}_{wt . \%} + 26.8 {Nb}_{wt . \%} + 2.54 {W}_{wt . \%} + 0.78 {Co}_{wt . \%} + 9. {Al}_{wt . \%} + 0.48 ( {Mo}_{wt . \%} - 4.58 ) ( {Mo}_{wt . \%} - 4.58 ) - 2.56 ( {Si}_{wt . \%} - 0.65 ) ( {Si}_{wt . \%} - 0.65 ) - 37.1 ( {Nb}_{wt . \%} - 0.09 ) ( {Nb}_{wt . \%} - 0.09 ) + 2.67 ( {Mo}_{wt . \%} - 4.58 ) ( {Si}_{w t . \%} - 0.65 ) + 4. ( {Ni}_{wt . \%} - 2.95 ) ( {Ti}_{wt . \%} - 0.12 ) + 0.008 ( {Ni}_{wt . \%} - 2.95 ) ( {Mo}_{wt . \%} - 4.58 ) ;$$

$$wherein 23 \leq S F \leq 50 ;$$

an austenite reversion factor (ARF) that is defined by the equation:

$$A R F = 102 - 5.8 {Ni}_{wt . \%} - 7.4 {Mn}_{wt . \%} - 0.9 {Cr}_{wt . \%} + 2. {Si}_{wt . \%} + 0.04 {Mo}_{wt . \%} - 1.1 {Cu}_{wt . \%} + 0.6 {Co}_{wt . \%} + 3.1 {Al}_{wt . \%} ; wherein 50 \leq A R F \leq 100 ;$$

a heat transfer factor (HTF) that is defined by the equation:

$$H T F = 7.1 - 0.5 {Mn}_{wt . \%} - 0.32 {Cr}_{wt . \%} - 0.43 {Si}_{wt . \%} - 0.15 ( {Mo}_{wt . \%} + {W}_{wt . \%} + {Nb}_{wt . \%} ) - 0.03 {Co}_{wt . \%} - 0.43 {Al}_{wt . \%} + 3.09 Exp ( - 0 \text{.28} {Ni}_{wt . \%} ) ; wherein 4.9 \leq H T F \leq 9 ;$$

and
a high temperature austenite stability factor (HTASF) that is defined by the equation:

$$H T A S F = 12 {Ni}_{wt . \%} + 10.2 {Mn}_{wt . \%} + 320 {C}_{wt . \%} - 0.4 ( {Cr}_{wt . \%} ) 2 + 3.2 {Cr}_{wt . \%} - 5.7 {Si}_{wt . \%} - 9.4 {Mo}_{wt . \%} + 5.7 {Cu}_{wt . \%} - 13 {Ti}_{wt . \%} - 14.8 {Nb}_{wt . \%} - 1.2 {W}_{wt . \%} + 3.7 {Co}_{wt . \%} - 29.3 {Al}_{wt . \%} - 97.3 {V}_{wt . \%} - 0 \text{.46} ; wherein \text{-15} \leq H T A S F \leq 40.$$

The printable steel alloy used in the method can comprise a NiCoTi factor (NiCoTiF) that is defined as

$$NiCoTiF = {Ni}_{wt . \%} + {Co}_{wt . \%} + {Ti}_{wt . \%} ; wherein 0 \leq NiCoTiF \leq 10.$$

The method can further comprising a solution treatment step, a quenching step, and a subsequent age-hardening step, the solution treatment step being conducted at temperatures from 950 to 1065° C. for 1 h or other suitable times according to best practices, followed by quenching in water, air, forced air, oil, gas, or other suitable quenching medium, such that the as-quenched hardness is equal to or less than 37 HRC after solution treatment at 1065° C. for 1 h and water quenching.

The article can be printed by laser powder bed fusion additive manufacturing with a volumetric energy density (VED) ranging from 90.28 J/mm3 to 150 J/mm3, layer thickness of 0.03 mm, a build plate temperature of nominally 100° C., and power (P), scan velocity (v), hatch spacing (h), and power to velocity ratio (P/v) in accordance with the ranges below in order to achieve porosity levels equal to 0.1% or less:
at a VED of 90.28 J/mm3: 135.4 W≤P≤292.5 W, 500 mm/s≤v≤900 mm/s, 0.22 W s/mm≤P/v≤0.33 W s/mm, and 0.08 mm≤h≤0.12 mm;
at a VED of 97.22 J/mm3: 145.8 W≤P≤315 W, 500 mm/s≤v≤900 mm/s, 0.23 W s/mm≤P/v≤0.35 W s/mm, and 0.08 mm≤h≤0.12 mm;
at a VED of 125 J/mm3: 157.5 W≤P≤337.5 W, 700 mm/s≤v≤900 mm/s, 0.225 W s/mm≤P/v≤0.38 W s/mm, and 0.06 mm≤h≤0.10 mm; or,
at a VED of 150 J/mm3: 189 W≤P≤360 W, 700 mm/s≤v≤900 mm/s, 0.27 W s/mm≤P/v≤0.45 W s/mm, and 0.06 mm≤h≤0.10 mm.

The article may also be printed at any value of VED between 90.28 J/mm3 and 97.22 J/mm3, 97.22 J/mm3 and 125 J/mm3, and between 125 J/mm3 and 150 J/mm3 with the ranges of P, v, h, and P/v between the two closest data points being defined by linear interpolation as a function of VED.

The method can further comprising a solution treatment step, a quenching step, and a subsequent age-hardening step, the solution treatment step being conducted at temperatures from 950 to 1065° C. for 1 h or other suitable times according to best practices, followed by quenching in water, air, forced air, oil, gas, or other suitable quenching medium, such that the as-quenched hardness is equal to or less than 37 HRC after solution treatment and quenching. The aging step being conducted at 550 C for 4 h or other suitable time according to best practices

The printable steel alloy can have an average hardness in the as-printed condition, solution treated condition, and/or as-printed then solution treated condition that is equal to or less than 37 HRC.

The printable steel alloy can have a room temperature ultimate tensile strength that is equal to or greater than 1200 MPa and the average room temperature hardness is equal or greater than 39 HRC after solution treating and then aging at 550° C. for 4 h.

The printable steel alloy can have an ultimate tensile strength at 550° C. that is equal to or greater than 700 MPa after solution treating and then aging at 550° C. for 4 h.

The printable steel alloy can have a room temperature hardness of the alloy that is equal to or greater than 32 HRC after the alloy is solution treated, aged, and subsequently long term thermally soaked at 550° C. for 500 h.

The printable steel alloy can have a thermal diffusivity that is greater than or equal to 6 mm²/s in the temperature range including 100° C. up to and including 300° C., and greater than 4.5 mm²/s from temperatures greater than 300° C. up to and including 500° C.

The printable steel alloy can have an Ae1 temperature of the steel that is greater than or equal to 550° C.

The printable steel alloy can have an average hardness in the as-printed condition, solution treated condition, and/or as-printed then solution treated condition that is equal to or less than 37 HRC,

The printable steel alloy can have a room temperature ultimate tensile strength is equal to or greater than 1200 MPa and the room temperature average hardness that is equal or greater than 39 HRC after solution treating and then aging at 550° C. for 4 h, an ultimate tensile strength at 550° C. that is equal to or greater than 700 MPa after solution treating and then aging at 550° C. for 4 h, a room temperature hardness of the alloy that is equal to or greater than 32 HRC after the alloy is solution treated, aged, and subsequently long term thermally soaked at 550° C. for 500 h, a thermal diffusivity that is greater than or equal to 6 mm²/s in the temperature range including 100° C. up to and including 300° C., and greater than 4.5 mm²/s from temperatures greater than 300° C. up to and including 500° C., and an Ae1 temperature of the steel that is greater than or equal to 550° C.

A die according to the invention can comprise a printed steel alloy, the printed steel alloy comprising, in weight percent based on the total weight of the alloy: 1.75 to 5 Cu; 1.9 to 8 Mo; 0 to 4.25 Ni; 0 to 1 Mn; 0 to 0.1 C; 0 to 6 Cr; 0 to 2.1 Si; 0 to 1.6 Ti; 0 to 1 Nb; 0 to 7 W; 0 to 6 Co; 0 to 1 Al; 0 to 0.1 N; 0 to 0.04 S; 0 to 0.005 B; 0 to 0.1 V; balance Fe.

### BRIEF DESCRIPTION OF THE DRAWINGS

There are shown in the drawings embodiments that are presently preferred it being understood that the invention is not limited to the arrangements and instrumentalities shown, wherein:

FIG. 1 is a schematic perspective view of articles printed with the alloys and according to the methods of the invention.

FIG. 2 is an equilibrium phase fraction plot for alloy 1.

FIG. 3 is an equilibrium phase fraction plot for alloy 2.

FIG. 4 is an equilibrium composition plot of the BCC matrix phase of alloy 1.

FIG. 5 is an equilibrium composition plot of the BCC matrix phase of alloy 2.

FIG. 6 shows the room-temperature hardness of the inventory alloys and reference alloys listed in Table 4 after solution treatment at 1065° C. for 1 h, water quenching, and aging at 550° C. for 4 h.

FIG. 7 is an equilibrium phase fraction plot for M300.

FIG. 8 is an equilibrium composition plot of the BCC matrix phase of M300.

FIG. 9 is an EBSD IPF map from alloy 7 after laser melting and rapid solidification, followed by aging at 550 C for 4 h. IPF maps are in the z-x plane and show orientation along the “z” direction (parallel to the laser beam).

FIG. 10 shows the thermal diffusivity of alloys 7, 18, 28, 29, 31, 32, 36, and 37 and commercial reference alloys H13 and M300.

FIG. 11 is an equilibrium phase fraction plot for alloy 7.

FIG. 12 is an equilibrium composition plot of the BCC matrix phase of Alloy 7.

FIG. 13 is a comparison of the thermal conductivity of alloy 7 in the cast, austenitized, water quenched, and aged (550 C for 4 h) conditions with that of the commercial alloys H13 and M300.

### DETAILED DESCRIPTION OF THE INVENTION

A printable steel alloy according to the invention comprises, consists essentially of, or consists of, in weight percent based on the total weight of the alloy:
1.75 to 5 Cu;
1.9 to 8 Mo;
0 to 4.25 Ni;
0 to 1 Mn;
0 to 0.1 C;
0 to 6 Cr;
0 to 2.1 Si;
0 to 1.6 Ti;
0 to 1 Nb;
0 to 7 W;
0 to 6 Co;
0 to 1 Al;
0 to 0.1 N;
0 to 0.04 S;
0 to 0.005 B;
0 to 0.1 V; and,
balance Fe.
   The steel may also include trace amounts of unavoidable impurities introduced during steel making, including Phosphorous (P), Tin (Sn), Lead (Pb), Arsenic (As), and Antimony (Sb). P shall be ≤0.03 wt. %, Sn shall be ≤0.025 wt. %, Pb less than ≤0.03 wt. %, As less than ≤0.03 wt. %, and Sb less than ≤0.03 wt. %.

The printable steel alloy can have a strength factor. The strength factor (SF) is defined by the equation:

$$S F = \text{-15.1} - 0.39 {Ni}_{wt . \%} + 0.95 {Mn}_{wt . \%} + 75.2 {C}_{wt . \%} + 2.29 {Cr}_{wt . \%} + 11.6 {Si}_{wt . \%} + 5.93 {Mo}_{wt . \%} + 2.91 {Cu}_{wt . \%} + 10.3 {Ti}_{wt . \%} + 26.8 {Nb}_{wt . \%} + 2.54 {W}_{wt . \%} + 0.78 {Co}_{wt . \%} + 9. {Al}_{wt . \%} + 0.48 ( {Mo}_{wt . \%} - 4.58 ) ( {Mo}_{wt . \%} - 4.58 ) - 2.56 ( {Si}_{wt . \%} - 0.65 ) ( {Si}_{wt . \%} - 0.65 ) - 37.1 ( {Nb}_{wt . \%} - 0.09 ) ( {Nb}_{wt . \%} - 0.09 ) + 2.67 ( {Mo}_{wt . \%} - 4.58 ) ( {Si}_{wt . \%} - 0.65 ) + 4. ( {Ni}_{wt . \%} - 2.95 ) ( {Ti}_{wt . \%} - 0.12 ) + 0.0 \; 08 ( {Ni}_{wt . \%} - 2.95 ) ( {Mo}_{wt . \%} - 4.58 )$$

where the indicated element with the subscript “wt. %” means the weight percent of that element, based on the total weight of the alloy. Thus if Ni_{wt. %} is 4 wt. % and Mn_{wt. %} is 0.5 wt. %, the above SF equation would be −15.1-0.39 (4)+0.95 (0.5) . . . and so on. The SF is proportional to the hardness of the alloy after age-hardening. The SF can be used to select the composition which will achieve the desired hardness for the application. The SF for the present alloys is 23≤SF≤5. The SF can be 23, 24, 25, 26, 27, 28, 29, 30, 31, 32, 33, 34, 35, 36, 37, 38, 39, 40, 41, 42, 43, 44, 45, 46, 47, 48, 49, or 50. The SF can be within a range of any high value and low value including or between 23 and 50.

The printable steel alloy can have an austenite reversion factor (ARF). The ARF is defined by the equation:

$$A R F = 102 - 5.8 {Ni}_{wt . \%} - 7.4 {Mn}_{wt . \%} - 0.9 {Cr}_{wt . \%} + 2. {Si}_{wt . \%} + 0.04 {Mo}_{wt . \%} - 1.1 {Cu}_{wt . \%} + 0.6 {Co}_{wt . \%} + 3.1 {Al}_{wt . \%} ;$$

The ARF for the present alloys is 50≤ARF≤100. The ARF can be 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100. The ARF can be within a range of any high value and low value including or between 50 and 100. The printable steel alloy can for example be 50≤ARF≤100. The ARF is correlated with the tendency for steels to undergo austenite reversion during exposure to temperatures above the Ae1 temperature. If the ARF is below 50, austenite reversion will occur during exposure to temperatures above 400° C. Die surfaces in high pressure aluminum die casting experience temperatures in excess of 400° C. during contact with molten aluminum, and therefore will be susceptible to austenite reversion if the ARF is less than 50.

The printable steel alloy can have a heat transfer factor (HTF). The heat transfer factor (HTF) is defined by the equation:

$$H T F = 7.1 - 0.5 {Mn}_{wt . \%} - 0.32 {Cr}_{wt . \%} - 0.43 {Si}_{wt . \%} - 0.15 ( {Mo}_{wt . \%} + {W}_{wt . \%} + {Nb}_{wt . \%} ) - 0.03 {Co}_{wt . \%} - 0.43 {Al}_{wt . \%} + 3.09 Exp ( - 0 \text{.28} {Ni}_{wt . \%} )$$

The HTF for the present alloys is 4.9≤HTF≤9. The HTF can be 4.9, 5, 5.1, 5.2, 5.3, 5.4, 5.5, 5.6, 5.7, 5.8, 5.9, 6, 6.1, 6.2, 6.3, 6.4, 6.5, 6.6, 6.7, 6.8, 6.9, 7, 7.1, 7.2, 7.3, 7.4, 7.5, 7.6, 7.7, 7.8, 7.9, 8, 8.1, 8.2, 8.3, 8.4, 8.5, 8.6, 8.7, 8.8, 8.9 or 9. The HTF can be within a range of any high value and low value including or between 4.9 and 9. If the HTF is too low, heat transfer through the alloy will be limited and the die operating temperature will increase, which can reduce durability and longevity. In high pressure aluminum die casting, lower heat transfer will increase the die surface temperature and increase the tendency for thermal fatigue, erosion, soldering, and cracking. The present alloys are designed to simultaneously achieve a high HTF and SF. Cu is not included in the HTF as it has insignificant influence on the heat transfer of the steel after the steel has been aged. As such, Cu may increase the SF while not reducing the HTF.

The printable steel alloy can have an high temperature austenite stability factor. The high temperature austenite stability factor (HTASF) is defined by the equation:

$$H T A S F = 12 {Ni}_{wt . \%} + 10.2 {Mn}_{wt . \%} + 320 {C}_{wt . \%} - 0.4 {( {Cr}_{wt . \%} )}^{2} + 3.2 {Cr}_{wt . \%} - 5.7 {Si}_{wt . \%} - 9.4 {Mo}_{wt . \%} + 5.7 {Cu}_{wt . \%} - 13 {Ti}_{wt . \%} - 14.8 {Nb}_{wt . \%} - 1.2 {W}_{wt . \%} + 3.7 {Co}_{wt . \%} - 29.3 {Al}_{wt . \%} - 97.3 {V}_{wt . \%} - 0 \text{.46} ;$$

The HTASF for the present alloys is −15≤HTASF≤40. The HTASF can be −15, −14, −13, −12, −11, −10, −9, −8, −7, −6, −5, −4, −3, −2, −1, 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or 40. The HTASF can be within a range of any high value and low including or between −15 and 40. HTASF is correlated the stability of the austenite phase at high temperatures in the range of 800 to 1400° C. If the HTASF becomes too low, a fully austenitic microstructure cannot be achieved during solution treating, and ferrite will be present during solution treating and after quenching. Ferrite is a low strength microstructural constituent and can degrade mechanical properties. In contrast, if the HTASF is increased too much by the addition of austenite stabilizing elements Ni, Mn, C, and Cr, the HTF and ARF may each be unacceptably lowered.

The printable steel alloy can also have a NiCoTi factor (NiCoTiF). The NiCoTiF is defined by the equation:

$$NiCoTiF = {Ni}_{wt . \%} + {Co}_{wt . \%} + {T i}_{wt . \%} ;$$

The NiCoTiF factor for the present alloys is 0≤NiCoTiF≤10. The NiCoTiF factor can be 0, 0.5, 1, 1.5 2, 2.5, 3, 3.5, 4, 4.5, 5, 5.5, 6, 6.5, 7, 7.5, 8, 8.5, 9, 9.5 or 10. The NiCoTiF factor can be within a range of any high value and low value selected from these values. Ni, Co, and Ti have certain undesirable effects and characteristics as described above. Consequently, it is desirable to limit the amount of these elements in the alloy.

The printable steel alloy can comprise any combination of one or more of the above SF, ARF, HTF, HTASF, and NiCoTiF ranges. For example, an alloy can have ranges that meet the desired ranges for only some or all of the above factors, such as SF/ARF, ARF/HTF, ARF/HTF/HTASF, SF/ARF/HTF/HTASF or all of the above SF/ARF/HTF/HTASF/NiCoTiF. In one embodiment, the alloy can meet each of the following characteristics:
a strength factor (SF) defined by the equation:

$$S F = - 15.1 - 0.39 {Ni}_{wt . \%} + 0.95 {Mn}_{wt . \%} + 75.2 {C}_{wt . \%} + 2.29 {Cr}_{wt . \%} + 11.6 {Si}_{wt . \%} + 5.93 {Mo}_{wt . \%} + 2.91 {Cu}_{wt . \%} + 10.3 {Ti}_{wt . \%} + 26.8 {Nb}_{wt . \%} + 2.54 {W}_{wt . \%} + 0.78 {Co}_{wt . \%} + 9. {Al}_{wt . \%} + 0.48 ( {Mo}_{wt . \%} - 4.58 ) ( {Mo}_{wt . \%} - 4.58 ) - 2.56 ( {Si}_{wt . \%} - 0.65 ) ( {Si}_{wt . \%} - 0.65 ) - 37.1 ( {Nb}_{w t \%} - 0.09 ) ( {Nb}_{wt . \%} - 0.09 ) + 2.67 ( {Mo}_{wt . \%} - 4.58 ) ( {Si}_{wt . \%} - 0.65 ) + 4. ( {Ni}_{wt . \%} - 2.95 ) ( {Ti}_{wt . \%} - 0.12 ) + 0.008 ( {Ni}_{wt . \%} - 2.95 ) ( {Mo}_{wt . \%} - 4.58 ) ; wherein 23 \leq S F \leq 50 ;$$

an austenite reversion factor (ARF) defined by the equation:

$$A R F = 102 - 5.8 {Ni}_{wt . \%} - 7.4 {Mn}_{wt . \%} - 0.9 {Cr}_{wt . \%} + 2. {Si}_{wt . \%} + 0.04 {Mo}_{wt . \%} - 1.1 {Cu}_{wt . \%} + 0.6 {Co}_{wt . \%} + 3.1 {Al}_{wt . \%} ; wherein 50 \leq A R F \leq 100 ;$$

a heat transfer factor (HTF) defined by the equation:

$$H T F = 7.1 - 0.5 {M n}_{wt . \%} - 0.32 {Cr}_{wt . \%} - 0.43 {Si}_{wt . \%} - 0.15 ( {Mo}_{wt . \%} + {W}_{wt . \%} + {Nb}_{wt . \%} ) - 0.03 {Co}_{wt . \%} - 0.43 {Al}_{wt . \%} + 3.09 Exp ( - 0 \text{.28} {Ni}_{wt . \%} ) ; wherein 4.9 \leq H T F \leq 9 ;$$

a high temperature austenite stability factor (HTASF) defined by the equation:

$$H T A S F = 12 {Ni}_{wt . \%} + 10.2 {Mn}_{wt . \%} + 320 {C}_{wt . \%} - 0.4 {( {Cr}_{wt . \%} )}^{2} + 3.2 {Cr}_{wt . \%} - 5.7 {Si}_{wt . \%} - 9.4 {Mo}_{wt . \%} + 5.7 {Cu}_{wt . \%} - 13 {Ti}_{wt . \%} - 14.8 {Nb}_{wt . \%} - 1.2 {W}_{wt . \%} + 3.7 {Co}_{wt . \%} - 29.3 {Al}_{wt . \%} - 97.3 {V}_{wt . \%} - 0.46 ; wherein \text{-15} \leq H T A S F \leq 40 ;$$

and
a NiCoTiF is defined by the equation:

$$NiCoTiF = Niwt . \% + Cowt . \% + Tiwt . \% ; wherein 0 \leq NiCoTiF \leq 10$$

A method for printing a steel alloy, comprising the steps of: providing a steel alloy feedstock, the feedstock comprising, consisting essentially of, or consisting of, in weight percent based on the total weight of the alloy:
1.75 to 5 Cu;
1.9 to 8 Mo;
0 to 4.25 Ni;
0 to 1 Mn;
0 to 0.1 C;
0 to 6 Cr;
0 to 2.1 Si;
0 to 1.6 Ti;
0 to 1 Nb;
0 to 7 W;
0 to 6 Co;
0 to 1 Al;
0 to 0.1 N;
0 to 0.04 S;
0 to 0.005 B;
0 to 0.1 V; and,
balance Fe;
heating the feedstock to a melting temperature; and,
printing and article with the feedstock.

The method can include providing an alloy with a strength factor (SF) that is defined by the equation:

$$S F = - 15.1 - 0.39 {Ni}_{wt . \%} + 0.95 {Mn}_{wt . \%} + 75.2 {C}_{wt . \%} + 2.29 {Cr}_{wt . \%} + 11.6 {Si}_{wt . \%} + 5.93 {Mo}_{wt . \%} + 2.91 {Cu}_{wt . \%} + 10.3 {Ti}_{wt . \%} + 26.8 {Nb}_{wt . \%} + 2.54 {W}_{wt . \%} + 0.78 {Co}_{wt . \%} + 9. {Al}_{wt . \%} + 0.48 ( {Mo}_{wt . \%} - 4.58 ) ( {Mo}_{wt . \%} - 4.58 ) - 2.56 ( {Si}_{wt . \%} - 0.65 ) ( {Si}_{wt . \%} - 0.65 ) - 37.1 ( {Nb}_{wt . \%} - 0.09 ) ( {Nb}_{wt . \%} - 0.09 ) + 2.67 ( {Mo}_{wt . \%} - 4.58 ) ( {Si}_{wt . \%} - 0.65 ) + 4. ( {Ni}_{wt . \%} - 2.95 ) ( {Ti}_{wt . \%} - 0.12 ) + 0.008 ( {Ni}_{wt . \%} - 2.95 ) ( {Mo}_{wt . \%} - 4.58 ) and wherein 23 \leq S F \leq 50.$$

The method can include providing an alloy with an austenite reversion factor (ARF) that is defined by the equation:

$$A R F = 102 - 5.8 {Ni}_{wt . \%} - 7.4 {Mn}_{wt . \%} - 0.9 {Cr}_{wt . \%} + 2. {Si}_{wt . \%} + 0.04 {Mo}_{wt . \%} - 1.1 {Cu}_{wt . \%} + 0.6 {Co}_{wt . \%} + 3.1 {Al}_{wt . \%} ;$$

$$and wherein 50 \leq A R F \leq 100.$$

The method can include providing an alloy with a heat transfer factor (HTF) that is defined by the following equation:

$$H T F = 7.1 - 0.5 {Mn}_{wt . \%} - 0.32 {Cr}_{wt . \%} - 0.43 {Si}_{wt . \%} - 0.15 ( {Mo}_{wt . \%} + {W}_{wt . \%} + {Nb}_{wt . \%} ) - 0.03 {Co}_{wt . \%} - 0.43 {Al}_{wt . \%} + 3.09 Exp ( - 0 \text{.28} {Ni}_{wt . \%} ) ;$$

$$and wherein 4.9 \leq H T F \leq 9.$$

The method can include providing an alloy with a high temperature austenite stability factor (HTASF) that is defined by the equation:

$$H T A S F = 12 {Ni}_{wt . \%} + 10.2 {Mn}_{wt . \%} + 320 {C}_{wt . \%} - 0.4 {( {Cr}_{wt . \%} )}^{2} + 3.2 {Cr}_{wt . \%} - 5.7 {Si}_{wt . \%} - 9.4 {Mo}_{wt . \%} + 5.7 {Cu}_{wt . \%} - 13 {Ti}_{wt . \%} - 14.8 {Nb}_{wt . \%} - 1.2 {W}_{wt . \%} + 3.7 {Co}_{wt . \%} - 29.3 {Al}_{wt . \%} - 97.3 {V}_{wt . \%} - 0.46 ;$$

$$and wherein - 15 \leq H T A S F \leq 40.$$

The method can include providing an alloy with:
a strength factor (SF) that is defined by the equation:

$$S F = - 1 5.1 - 0.39 {Ni}_{wt . \%} + 0.95 {Mn}_{wt . \%} + 75.2 {C}_{wt . \%} + 2.29 {Cr}_{wt . \%} + 11.6 {Si}_{wt . \%} + 5.93 {Mo}_{wt . \%} + 2.91 {Cu}_{wt . \%} + 10.3 {Ti}_{wt . \%} + 26.8 {Nb}_{wt . \%} + 2.54 {W}_{wt . \%} + 0.78 {Co}_{wt . \%} + 9. {Al}_{wt . \%} + 0.48 ( {Mo}_{wt . \%} - 4.58 ) ( {Mo}_{wt . \%} - 4.58 ) - 2.56 ( {Si}_{wt . \%} - 0.65 ) ( {Si}_{wt . \%} - 0.65 ) - 37.1 ( {Nb}_{wt . \%} - 0.09 ) ( {Nb}_{wt . \%} - 0.09 ) + 2.67 ( {Mo}_{wt . \%} - 4.58 ) ( {Si}_{wt . \%} - 0.65 ) + 4. ( {Ni}_{wt . \%} - 2.95 ) ( {Ti}_{wt . \%} - 0.12 ) + 0.0 \; 08 ( {Ni}_{wt . \%} - 2.95 ) ( {Mo}_{wt . \%} - 4.58 )$$

$$and wherein 23 \leq S F \leq 50 ;$$

an austenite reversion factor (ARF) that is defined by the equation:

$$A R F = 105.5 - 13.8 {Ni}_{wt . \%} - 19.8 {Mn}_{wt . \%} + 0.2 {Cr}_{wt . \%} + 2.6 {Si}_{wt . \%} + 0.5 {Mo}_{wt . \%} - 2.1 {Cu}_{wt . \%} + 0.6 {Co}_{wt . \%} + 3.1 {Al}_{wt . \%} ; and wherein 50 \leq A R F \leq 100 ;$$

a heat transfer factor (HTF) that is defined by the equation:

$$H T F = 7.1 - 0.5 {Mn}_{wt . \%} - 0.32 {Cr}_{wt . \%} - 0.43 {Si}_{wt . \%} - 0.15 ( {Mo}_{wt . \%} + {W}_{wt . \%} + {Nb}_{wt . \%} ) - 0.03 {Co}_{wt . \%} - 0.43 {Al}_{wt . \%} + 3.09 Exp ( - 0 \text{.28} {Ni}_{wt . \%} ) ;$$

$$and wherein 4.9 \leq H T F \leq 9 ;$$

and
an high temperature austenite stability factor (HTASF) that is defined by the equation:

$$H T A S F = 12 {Ni}_{wt . \%} + 10.2 {Mn}_{wt . \%} + 320 {C}_{wt . \%} - 0.4 {( {Cr}_{wt . \%} )}^{2} + 3.2 {Cr}_{wt . \%} - 5.7 {Si}_{wt . \%} - 9.4 {Mo}_{wt . \%} + 5.7 {Cu}_{wt . \%} - 13 {Ti}_{wt . \%} - 14.8 {Nb}_{wt . \%} - 1.2 {W}_{wt . \%} + 3.7 {Co}_{wt . \%} - 29.3 {Al}_{wt . \%} - 97.3 {V}_{wt . \%} - 0.46 ; and wherein \text{-15} \leq H T A S F \leq 40.$$

The invention is suitable for different powder fabrication processes. Powder may be fabricated from the invention alloys by gas atomization, water atomization, centrifugal atomization, Plasma Rotating Electrode Process (PREP), or other suitable processes. The invention is also suitable for different additive manufacturing printing processes. Examples of such processes include Laser Powder Bed Fusion (LPBF), blown powder-direct energy deposition (BP-DED), wire arc DED (WA-DED), Binder Jet Additive Manufacturing (BJAM), and other suitable processes. The alloys of the invention can be used with other additive manufacturing processes. The material can be used in the as-printed condition, or the material can be further processed by heat treating depending on the microstructural and hardness needs of the application. The method can further comprise a solution treatment step, a quenching step, and an aging step to achieve high strength. The solution treatment step may be conducted at a temperature of 950° C. up to and including 1065° C. for 1 h, followed by quenching in air, forced air, oil, water, or pressurized gas such that the as-quenched hardness is equal to or less than 37 HRC after solution treatment.

The method can be used to print many different articles. The invention alloys are most suitable for applications requiring a combination of high strength above 26 HRC, good resistance to softening during long term thermal exposure, good thermal conductivity above 30 W/m-K, good oxidation resistance up to 500° C., and good corrosion resistance at ambient temperatures. One such article is a die. Dies are used in manufacturing processes such as die casting, high pressure die casting (HPDC), metal stamping, hot stamping or press hardening of sheet metal, injection molding, forging, extrusion, powder metallurgy, cutting and trimming, forming and deep drawing of sheet metal and others. In many of these die applications, high strength at elevated temperatures is needed in conjunction with good thermal conductivity above 30 W/m-K, corrosion resistance, and resistance to oxidation. Die inserts, which are small sub components of dies but with similar materials requirements, may also be printed from the invention alloys. The steel is also suitable for some internal engine components, such as pistons, which have complex geometries and require high strength, thermal conductivity, and oxidation resistance. The steel is also suitable for printing heat exchangers or components of heat exchangers.

In one aspect, the technologies described herein provide printable steel alloys for various higher temperature applications, including die-casting, and hot stamping. The steel alloys are designed to be printable by AM processes such as LPBF, BP-DED, and WA-DED. The alloy design approach described and discussed herein promotes a unique combination of good printability, post printing processability, and in-service performance. In service performance requires die steels to have excellent strength, thermal conductivity, and relatively high Ae1 temperature. The strength should be ≥23 HRC, more preferably ≥39 HRC, and even more preferably ≥42 HRC. The Ae1 temperature should be above 400° C., more preferably above 550° C. High strength is needed for dies to withstand high thermal cyclic fatigue and erosion and wear in applications such as HPDC and hot stamping. Good thermal conductivity is required to enable heat to be dissipated quickly to reduce thermal fatigue stress while also enhancing manufacturing efficiency by enabling shorter cycle times. A high Ae1 temperature is needed to prevent unwanted phase transformations, such as austenite reversion, which can lead to softening and dimensional instability of the die or component in service. In this aspect, the printable steel alloys described and discussed herein comprises, consists of, or consists essentially of, the elements and compositional ranges shown below in Table 3 for Example alloy 1 and Example Alloy 2. In some embodiments, additional trace or impurity elements not listed in Table 3, but that may generally be present in typical steel, may also be present in the alloys disclosed herein. More preferably, the steel may contain the printable steel alloys described and discussed herein comprise, consists of, or consists essentially of, the elements and compositional ranges shown below in Table 3 for Example Alloy 2.

TABLE 3
Exemplary alloy compositions in wt. %

| Alloying | Example | Example |
|---|---|---|
| element | Alloy 1 | Alloy 2 |
| Cu | 1.75-5 | 1.75-5 |
| Mo | 1.9-8 | 3.5-8 |
| Ni | 0-4.25 | 1.5-4.25 |
| Mn | 0-1 | 0-1 |
| C | 0-0.1 | 0-0.05 |
| Cr | 0-6 | 0-6 |
| Si | 0-2.1 | 0.4-2.1 |
| Ti | 0-1.6 | 0-0.15 |
| Nb | 0-1 | 0-0.75 |
| W | 0-7 | 0-7 |
| Co | 0-6 | 0-6 |
| Al | 0-1 | 0-0.75 |
| N | 0-0.1 | 0-0.1 |
| S | 0-0.04 | 0-0.04 |
| B | 0-0.005 | 0-0.003 |
| V | 0-0.1 | 0-0.1 |
| Fe | Balance | Balance |

The Copper (Cu) in weight percent based on the total weight of the alloy can be from 1.75 to 5 wt. %. The Cu weight % can be 1.75, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, or 5.0 wt. %. The weight % of Cu can be within a range of any high value and low value selected from these values.

The Molybdenum (Mo) in weight percent based on the total weight of the alloy can be from 1.9 to 8 wt. %. The Mo weight % can be 1.9, 2.0, 2.5, 3.0, 3.5, 4.0, 4.5, 5.0, 5.5, 6.0, 6.5, 7.0, 7.5, or 8.0 wt. %. The weight % of Mo can be within a range of any high value and low value selected from these values.

The Nickel (Ni) in weight percent based on the total weight of the alloy can be from 0 to 4.25 wt. %. The Ni weight % can be 0, 0.25, 0.5, 0.75, 1.0, 1.5, 2.0, 2.5, 3.0, 3.5, 3.75, 4.0, or 4.25 wt. %. The weight % of Ni can be within a range of any high value and low value selected from these values.

The Manganese (Mn) in weight percent based on the total weight of the alloy can be from 0 to 1 wt. %. The Mn weight % can be 0, 0.1, 0.2, 0.3, 0.4, 0.5, 0.6, 0.7, 0.8, 0.9, 1.0 wt. %. The weight % of Mn can be within a range of any high value and low value selected from these values.

The (Carbon) C in weight percent based on the total weight of the alloy can be from 0 to 0.1 wt. %. The C weight % can be 0, 0.01, 0.02, 0.03, 0.04, 0.05, 0.06, 0.07, 0.08, 0.09, or 0.1 wt. %. The weight % of C can be within a range of any high value and low value selected from these values.

The Chromium (Cr) in weight percent based on the total weight of the alloy can be from 0 to 6 wt. %. The Cr weight % can be 0, 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.25, 3.5, 3.75, 4.0, 4.25, 4.5, 4.75, 5.0, 5.25, 5.5, 5.75, or 6 wt. %. The weight % of Cr can be within a range of any high value and low value selected from these values.

The Silicon (Si) in weight percent based on the total weight of the alloy can be from 0 to 2.1 wt. %. The Si weight % can be 0, 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, or 2.1 wt. %. The weight % of Si can be within a range of any high value and low value selected from these values.

The Titanium (Ti) in weight percent based on the total weight of the alloy can be from 0 to 1.6 wt. %. The Ti weight % can be 0, 0.1, 0.2, 0.3, 0.4, 0.5, 0.6, 0.7, 0.8, 0.9, 1.0, 1.1, 1.2, 1.3, 1.4, 1.5, or 1.6 wt. %. The weight % of Ti can be within a range of any high value and low value selected from these values.

The Niobium (Nb) in weight percent based on the total weight of the alloy can be from 0 to 1.0 wt. %. The Nb weight % can be 0, 0.1, 0.2, 0.3, 0.4, 0.5, 0.6, 0.7, 0.8, 0.9, or 1.0 wt. %. The weight % of Nb can be within a range of any high value and low value selected from these values.

The Tungsten (W) in weight percent based on the total weight of the alloy can be from 0 to 7 wt. %. The W weight % can be 0, 0.5, 1.0, 1.5, 2.0, 2.5, 3.0, 3.5, 4.0, 4.5, 5.0, 5.5, 6.0, 6.5, or 7.0 wt. %. The weight % of W can be within a range of any high value and low value selected from these values.

The Cobalt (Co) in weight percent based on the total weight of the alloy can be from 0 to 6 wt. %. The Co weight % can be 0, 0.25, 0.5, 0.75 1, 1.25, 1.5, 1.75, 2, 2.5, 3, 3.5, 4, 4.5, 5, 5.5, or 6 wt. %. The weight % of Co can be within a range of any high value and low value selected from these values.

The Aluminum (Al) in weight percent based on the total weight of the alloy can be from 0 to 1 wt. %. The Al weight % can be 0, 0.05, 0.1, 0.15, 0.20, 0.25, 0.30, 0.35, 0.40, 0.45, 0.50, 0.55, 0.60, 0.65, 0.70, 0.75, 0.80, 0.85, 0.90, 0.95, or 1.0 wt. %. The weight % of Al can be within a range of any high value and low value selected from these values.

The Nitrogen (N) in weight percent based on the total weight of the alloy can be from 0 to 0.1 wt. %. The N weight % can be 0, 0.01, 0.02, 0.03, 0.04, 0.05, 0.06, 0.07, 0.08, 0.09, or 0.1 wt. %. The weight % of N can be within a range of any high value and low value selected from these values.

The Sulfur(S) in weight percent based on the total weight of the alloy can be from 0 to 0.04 wt. %. The S weight % can be 0, 0.001, 0.002, 0.003, 0.004, 0.005. 0.006, 0.007, 0.008, 0.009, 0.01, 0.011, 0.012, 0.013, 0.014, 0.015, 0.016, 0.017, 0.018, 0.019, 0.02, 0.025, 0.03, 0.035, or 0.04 wt. %. The weight % of S can be within a range of any high value and low value selected from these values.

The (Boron) B in weight percent based on the total weight of the alloy can be from 0 to 0.005 wt. %. The B weight % can be 0, 0.0001, 0.0002, 0.0003, 0.0004, 0.0005, 0.0006, 0.0007, 0.0008, 0.0009, 0.001, 0.0011, 0.0012, 0.0013, 0.0014, 0.0015, 0.0016, 0.0017, 0.0018, 0.0019, 0.002, 0.0021, 0.0022, 0.0023, 0.0024, 0.0025, 0.0026, 0.0027, 0.0028, 0.0029, 0.003, 0.0031, 0.0032, 0.0033, 0.0034, 0.0035, 0.0036, 0.0037, 0.0038, 0.0039, 0.004, 0.0041, 0.0042, 0.0043, 0.0044, 0.0045, 0.0046, 0.0047, 0.0048, 0.0049, or 0.005 wt. %. The weight % of B can be within a range of any high value and low value selected from these values.

The Vanadium (V) in weight percent based on the total weight of the alloy can be from 0 to 0.1 wt. %. The V weight % can be 0, 0.01, 0.02, 0.03, 0.04, 0.05, 0.06, 0.07, 0.08, 0.09, or 0.1 wt. %. The weight % of V can be within a range of any high value and low value selected from these values.

To demonstrate the exceptional potential for high strength combined with good thermal conductivity, a series of alloys according to the invention were computationally designed using equilibrium and kinetic thermodynamic modeling. Alloys 1 through 46, 48, and 49 were fabricated by arc melting and drop casting into 25.4 mm×25.4 mm×127 mm ingots. The invention alloys are alloys 2 through 13, 16-19, and 21-48 in Table 4. Alloys 1, 14, 15, 20, and 49 in Table 4 are reference alloys with composition outside the claimed range. The ingots were sectioned and either solution treated (ST), water quenched (WQ), and aged (A), ST+WQ+A.

The chemical compositions of alloys 1-49, with the exception of alloy 47 were measured using combustion-infrared absorbance for S and C, inert gas fusion for N and O, and inductively coupled plasma-atomic emission spectroscopy (ICP-AES) for the remaining elements, in accordance with ASTM E1019-24 and CAP-017U.

TABLE 4
Measured compositions in wt. % from arc melted ingots of disclosed alloys
2-13, 16-19, 21-48, and reference alloys 1, 14, 15, 20, and 49.

| Alloy | | | | | | | | | | | |
|---|---|---|---|---|---|---|---|---|---|---|---|
| Designation | Ni | Mn | C | Cr | Si | Mo | Cu | Ti | Nb | W | Co |
| 1 (Ref.) | 2.05 | 0.29 | <0.01 | 0.86 | 0.28 | 4.18 | <0.01 | <0.01 | <0.01 | 0.03 | <0.01 |
| 2 | 1.58 | 0.29 | <0.01 | 0.87 | 0.28 | 4.24 | 2.81 | <0.01 | <0.01 | 0.03 | <0.01 |
| 3 | 1.6 | 0.31 | 0.01 | 0.88 | 0.28 | 5.04 | 3.78 | <0.01 | <0.01 | 0.03 | <0.01 |
| 4 | 1.61 | 0.3 | <0.01 | 0.88 | 0.98 | 5.09 | 3.79 | <0.01 | <0.01 | 0.02 | <0.01 |
| 5 | 1.63 | 0.3 | 0.01 | 0.89 | 0.28 | 5.15 | 3.88 | 0.07 | <0.01 | <0.01 | <0.01 |
| 6 | 1.57 | 0.3 | <0.01 | 0.86 | 0.27 | 4.96 | 3.74 | <0.01 | 0.48 | 0.01 | <0.01 |
| 7 | 1.83 | 0.3 | 0.01 | 0.86 | 1 | 3.96 | 3.78 | <0.01 | 0.48 | <0.01 | <0.01 |
| 8 | 1.956 | 0.3 | 0.01 | 0.91 | 0.98 | 4.3 | 3.88 | <0.01 | 0.74 | <0.01 | <0.01 |
| 9 | 1.92 | 0.31 | 0.01 | <0.01 | 1 | 4.15 | 3.95 | <0.01 | 0.48 | <0.01 | <0.01 |
| 10 | 1.81 | 0.31 | 0.01 | <0.01 | 0.93 | 2.49 | 3.87 | <0.01 | 0.48 | 3.01 | 0.001 |
| 11 | 1.82 | 0.31 | 0.01 | 0.32 | 0.29 | 3.94 | 3.76 | <0.01 | 0.47 | <0.01 | <0.01 |
| 12 | 1.79 | 0.3 | 0.01 | 0.87 | 0.28 | 4.02 | 4.22 | <0.01 | 0.47 | <0.01 | <0.01 |
| 13 | 1.78 | 0.32 | 0.01 | 0.32 | 0.28 | 4.08 | 4.15 | <0.01 | 0.49 | <0.01 | <0.01 |
| 14 (Ref.) | 4.04 | <0.01 | <0.01 | <0.01 | <0.01 | <0.01 | 0.02 | 1.27 | <0.01 | <0.01 | <0.01 |
| 15 (Ref.) | 4.01 | <0.01 | <0.01 | <0.01 | <0.01 | 4.01 | 0.08 | 1.4 | <0.01 | 0.1 | 8.93 |
| 16 | 4.22 | <0.01 | <0.005 | <0.01 | <0.01 | 1.92 | 2.65 | 1.41 | 0 | <0.01 | 0 |
| 17 | 2.41 | <0.01 | <0.01 | 0.33 | <0.01 | 5.17 | 3.86 | <0.01 | 0.47 | <0.01 | <0.01 |
| 18 | 2.36 | <0.01 | <0.01 | 0.3 | <0.01 | 6.17 | 3.84 | <0.01 | <0.01 | <0.01 | <0.01 |
| 19 | 3.11 | <0.01 | <0.005 | 3.87 | <0.01 | 6.88 | 4.95 | <0.01 | 0 | <0.01 | 0 |
| 20 (Ref.) | <0.01 | <0.01 | <0.005 | 0.91 | <0.01 | <0.01 | 4.73 | <0.01 | 0 | 7.10 | 0 |
| 21 | 2.25 | <0.01 | <0.005 | 2.72 | 0.02 | 5.03 | 4.21 | <0.01 | 0 | <0.01 | 0 |
| 22 | 1.81 | 0.31 | <0.005 | 2.51 | 0.25 | 4.08 | 4.02 | <0.01 | 0 | 0.01 | 0 |
| 23 | 2.54 | 0.31 | <0.005 | 2.54 | 0.88 | 4.38 | 3.94 | <0.01 | 0 | <0.01 | <0.01 |
| 24 | 2.60 | <0.01 | <0.005 | 2.54 | 0.92 | 4.41 | 4 | <0.01 | 0 | 0.02 | <0.01 |
| 25 | 2.2 | 0.31 | <0.005 | 2.75 | 1.02 | 4.65 | 4.05 | 0 | <0.01 | <0.01 | <0.01 |
| 26 | 2.11 | 0.3 | <0.005 | 2.71 | 1.09 | 4.53 | 4.07 | 0 | <0.01 | 0.08 | <0.01 |
| 27 | 2.16 | 0.34 | <0.005 | 2.91 | 1 | 4.61 | 4 | 0 | <0.01 | <0.01 | <0.01 |
| 28 | 2.04 | 0.31 | <0.01 | 2.44 | 0.92 | 4.37 | 3.99 | <0.01 | <0.01 | <0.01 | <0.01 |
| 29 | 2.07 | 0.29 | <0.01 | 2.36 | <0.01 | 4.43 | 3.98 | <0.01 | <0.01 | <0.01 | <0.01 |
| 30 | 2.16 | 0.32 | <0.005 | 1.01 | 1.08 | 4.07 | 3.99 | 0 | 0.5 | 0.03 | <0.01 |
| 31 | 2.09 | 0.32 | <0.01 | 2.57 | 0.45 | 4.48 | 4.04 | <0.01 | <0.01 | <0.01 | <0.01 |
| 32 | 2.11 | 0.32 | <0.01 | 2.58 | 1.62 | 4.41 | 4.05 | <0.01 | <0.01 | <0.01 | <0.01 |
| 33 | 2.17 | 0.31 | <0.005 | 2.69 | 1.61 | 4.61 | 3.28 | 0 | <0.01 | 0.08 | <0.01 |
| 34 | 2.16 | 0.32 | <0.005 | 2.69 | 2.07 | 4.23 | 4.03 | 0 | <0.01 | <0.01 | <0.01 |
| 35 | 2.16 | 0.31 | <0.005 | 2.66 | 1.21 | 4.61 | 3.95 | 0 | <0.01 | 0.03 | <0.01 |
| 36 | 2.53 | 0.31 | <0.005 | 2.69 | 1.26 | 5.2 | 4.07 | 0 | <0.01 | <0.01 | <0.01 |
| 37 | 2.13 | 0.31 | <0.005 | 2.63 | 1.03 | 4.58 | 3.99 | 0 | <0.01 | <0.01 | 4.94 |
| 38 | 2.97 | 0.1 | <0.01 | 2.56 | 1.05 | 5.19 | 4.01 | <0.01 | <0.01 | <0.01 | <0.01 |
| 39 | 2.98 | 0.1 | 0.02 | 2.55 | 1.07 | 5.19 | 4.04 | 0.01 | <0.01 | <0.01 | <0.01 |
| 40 | 2.97 | 0.09 | 0.02 | 2.55 | 1.08 | 5.94 | 2.69 | 0.01 | <0.01 | <0.01 | <0.01 |
| 41 | 4.08 | 0.1 | <0.01 | 2.52 | 1.04 | 5.15 | 3.93 | <0.01 | <0.01 | <0.01 | <0.01 |
| 42 | 1.93 | 0.83 | <0.01 | 2.55 | 1.05 | 5.25 | 3.18 | <0.01 | <0.01 | <0.01 | <0.01 |
| 43 | 2.94 | 0.1 | <0.01 | 5.71 | 1.08 | 5.15 | 2.68 | <0.01 | <0.01 | <0.01 | <0.01 |
| 44 | 2.19 | 0.28 | 0.07 | 2.56 | 0.5 | 5.17 | 2.71 | 0.02 | <0.01 | <0.01 | <0.01 |
| 45 | 2.24 | 0.32 | 0.08 | 2.49 | 0.76 | 5.35 | 2.74 | 0.03 | <0.01 | <0.01 | <0.01 |
| 46 | 4.19 | 0.1 | <0.01 | 5.81 | 1.12 | 4.08 | 4.07 | <0.01 | <0.01 | <0.01 | <0.01 |
| 47 | 1.9 | 0.3 | 0.004 | 2.6 | 0.9 | 4.5 | 4.0 | — | — | — | — |
| 48 | 4.04 | 0.1 | <0.005 | 2.57 | 0.42 | 3.94 | 4.06 | <0.01 | 0 | 0.09 | 0 |
| 49(Ref.) | 3.97 | 0.1 | <0.005 | 10.81 | 1.04 | 3.9 | 4.01 | 0 | 0 | 0.01 | 0 |

| Alloy | | | | | | | | |
|---|---|---|---|---|---|---|---|---|
| Designation | Al | B | N | O | P | S | V | Fe |
| 1 (Ref.) | 0.01 | <0.005 | <0.01 | 0.01 | 0.005 | 0.004 | — | Bal. |
| 2 | 0.01 | <0.005 | <0.01 | <0.01 | 0.005 | 0.003 | — | Bal. |
| 3 | 0.01 | <0.005 | <0.01 | <0.01 | <0.005 | 0.003 | — | Bal. |
| 4 | 0.01 | <0.005 | <0.01 | <0.01 | 0.005 | 0.003 | — | Bal. |
| 5 | 0.01 | <0.005 | <0.01 | <0.01 | <0.005 | 0.003 | — | Bal. |
| 6 | <0.01 | <0.005 | <0.01 | 0.01 | <0.005 | 0.003 | — | Bal. |
| 7 | <0.01 | <0.005 | 0.01 | <0.01 | <0.005 | 0.001 | — | Bal. |
| 8 | <0.01 | <0.005 | 0.01 | <0.01 | <0.005 | 0.001 | — | Bal. |
| 9 | <0.01 | <0.005 | 0.01 | <0.01 | <0.005 | <0.001 | — | Bal. |
| 10 | <0.01 | <0.005 | 0.01 | <0.01 | <0.005 | 0.001 | — | Bal. |
| 11 | <0.01 | <0.005 | 0.03 | <0.01 | <0.005 | <0.001 | — | Bal. |
| 12 | <0.01 | <0.005 | 0.02 | <0.01 | <0.005 | <0.001 | — | Bal. |
| 13 | <0.01 | <0.005 | 0.02 | <0.01 | <0.005 | <0.001 | — | Bal. |
| 14 (Ref.) | 0.09 | <0.005 | 0.013 | 0.006 | <0.005 | <0.005 | — | Bal. |
| 15 (Ref.) | 0.09 | <0.005 | 0.011 | 0.005 | <0.005 | 0.001 | — | Bal. |
| 16 | 0.1 | <0.005 | 0.009 | 0.006 | <0.005 | <0.005 | — | Bal. |
| 17 | <0.01 | <0.005 | 0.03 | 0.02 | <0.005 | <0.001 | — | Bal. |
| 18 | 0.01 | <0.005 | 0.02 | 0.02 | <0.005 | 0.001 | — | Bal. |
| 19 | <0.01 | <0.005 | 0.034 | 0.022 | <0.005 | <0.005 | — | Bal. |
| 20 (Ref.) | <0.01 | <0.005 | 0.042 | 0.033 | <0.005 | <0.005 | — | Bal. |
| 21 | <0.01 | <0.005 | 0.022 | 0.016 | <0.005 | <0.005 | — | Bal. |
| 22 | <0.01 | <0.005 | 0.034 | 0.016 | <0.005 | <0.005 | — | Bal. |
| 23 | <0.01 | <0.005 | 0.022 | 0.008 | <0.005 | <0.005 | — | Bal. |
| 24 | <0.01 | <0.005 | 0.024 | 0.009 | <0.005 | <0.005 | — | Bal. |
| 25 | <0.01 | <0.005 | 0.022 | <0.01 | <0.005 | 0.001 | — | Bal. |
| 26 | <0.01 | <0.005 | 0.017 | 0.008 | <0.005 | 0.001 | — | Bal. |
| 27 | <0.01 | <0.005 | 0.022 | 0.01 | <0.005 | 0.001 | — | Bal. |
| 28 | <0.01 | <0.005 | <0.005 | <0.01 | <0.005 | 0.002 | — | Bal. |
| 29 | <0.01 | <0.005 | <0.005 | <0.01 | <0.005 | 0.003 | — | Bal. |
| 30 | <0.01 | <0.005 | 0.013 | 0.007 | <0.005 | 0.001 | — | Bal. |
| 31 | <0.01 | <0.005 | <0.005 | <0.01 | <0.005 | 0.002 | — | Bal. |
| 32 | <0.01 | <0.005 | <0.005 | <0.01 | <0.005 | 0.002 | — | Bal. |
| 33 | <0.01 | <0.005 | <0.005 | 0.014 | <0.005 | 0.002 | — | Bal. |
| 34 | <0.01 | <0.005 | <0.005 | 0.015 | <0.005 | 0.002 | — | Bal. |
| 35 | <0.01 | <0.005 | <0.005 | 0.011 | <0.005 | 0.002 | — | Bal. |
| 36 | <0.01 | <0.005 | <0.005 | 0.01 | <0.005 | 0.002 | — | Bal. |
| 37 | <0.01 | <0.005 | <0.005 | 0.011 | <0.005 | 0.002 | — | Bal. |
| 38 | <0.01 | <0.005 | <0.001 | 0.011 | <0.005 | 0.002 | — | Bal. |
| 39 | <0.01 | <0.005 | <0.001 | 0.005 | <0.005 | 0.002 | — | Bal. |
| 40 | <0.01 | <0.005 | <0.001 | 0.005 | <0.005 | 0.002 | — | Bal. |
| 41 | <0.01 | <0.005 | <0.001 | 0.013 | <0.005 | 0.002 | — | Bal. |
| 42 | <0.01 | <0.005 | <0.001 | 0.012 | <0.005 | 0.003 | — | Bal. |
| 43 | <0.01 | <0.005 | <0.001 | 0.016 | <0.005 | 0.003 | — | Bal. |
| 44 | <0.01 | <0.005 | <0.001 | 0.004 | <0.005 | 0.003 | 0.09 | Bal. |
| 45 | <0.01 | <0.005 | 0.001 | 0.004 | <0.005 | 0.002 | 0.09 | Bal. |
| 46 | 0.01 | <0.005 | 0.014 | 0.018 | <0.005 | 0.002 | <0.01 | Bal. |
| 47 | — | N/D | 0.003 | 0.04 | 0.006 | 0.002 | — | Bal. |
| 48 | 0.7 | <0.005 | 0.02 | <0.005 | <0.005 | <0.005 | — | Bal. |
| 49(Ref.) | 0 | <0.005 | <0.005 | 0.023 | <0.005 | 0.002 | 0 | Bal. |

The ST was typically conducted at temperatures of 950 or 1065° C. for 1 h unless otherwise noted in the tables, with the exception of Alloy 9 and reference alloy 20, which were solution treated at 1120° C. and 1160° C., respectively, each for 1 h. Reference alloys 14 and 15 were austenitized using a two-step treatment of 1150° C. for 4 h followed by 1065° C. for 1 h. Aging was typically conducted in tube furnaces at 550° C. for 4 h unless otherwise specified. Reference alloys 14 and 15 were austenitized using a two-step treatment of 1150° C. for 4 h followed by 1065° C. for 1 h.

To demonstrate the microstructural characteristics of the invention alloys under rapid solidification, alloy 7 was arc melted and cast into an ingot approximately 25.4 mm×25.4 mm×127 mm in length. Subsequently, a rectangular plate of steel approximately 25.4 mm×32 mm×7 mm in thickness was extracted from the ingot for laser track studies. The as-cast ingot was then solution treated at 1065° C. for 1 h and quenched in water. The surface of the steel block was melted by a series of laser passes. The laser power used was 2750 W with a speed of 486 mm/minute and this was performed on a Mazak VTC800G SR AM HWD system. Three laser tracks were performed, a track with one pass, a track with two passes (back and forth), and a track with three passes (down, back, and down again). The block was sliced and subsequently aged at 550° C. for 4 h. Vickers hardness measurements were conducted on the laser melted material in the as-solution treated and as-solution treated and aged conditions. Cracking was not observed in the laser melted material.

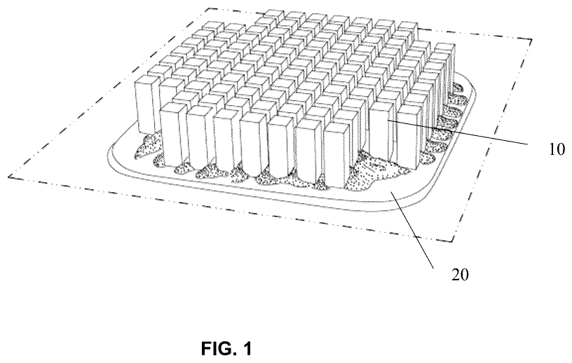

To demonstrate the printability of the invention alloys by LPBF, alloy 47 was cast then atomized into powder for AM trials by LPBF. Alloy 47's chemistry is listed in Table 4 and it's powder size characteristics are listed in Table 5. For alloy 47 powder, C and S were determined by an Eltra CS-800 analyzer, O and N were determined by an Eltra 900 analyzer, and metallic elements were determined by ThermoFisher ICAP 7400. Square bars of alloy 47 were printed with ˜7 mm edge length and ˜22 mm height in a Nikon SLM Solutions SLM 125 [Nikon SLM Solution, Lübeck]. Prior to printing, alloy 47 powder was loaded into a container in an argon filled glovebox in preparation for 3D printing. A 125×125×25 mm mild steel baseplate heated to 100° C. was utilized as the substrate. Printing was performed under an argon gas atmosphere. Processing parameters were varied; laser power between 80 W and 360 W, velocity between 300 mm/s and 1200 mm/s, and hatch spacing between 0.06 and 0.14 mm. The layer thickness was set to 0.03 mm. Two builds were conducted, each with the same part layout but using different processing parameters to build the parts. One hundred and five parts 10 were printed on the baseplate 20 (depicted in FIG. 1) for each build and were removed from the baseplate electro discharge machining (Fanuc Series 18i-W EDM [Fanuc, Oshino-Mura, JP]).

TABLE 5
Powder size characteristics of alloy 47.

| Particle | Cumulative % |
|---|---|
| Size (μm) | Pass |
| 176 | 100 |
| 125 | 100 |
| 88 | 100 |
| 62 | 99.6 |
| 44 | 89 |
| 31 | 63.9 |
| 16 | 14.5 |
| 11 | 1.9 |
| 7.8 | 0.4 |
| 5.5 | 0.3 |
| 3.9 | 0 |
| 2.8 | 0 |
| 1.4 | 0 |
| 0.9 | 0 |

| Percentile | Particle Size (μm) |
|---|---|
| d10 | 14.2 |
| d50 | 26 |
| d90 | 44.9 |

Porosity measurements were performed using a high-throughput X-ray computed tomography (XCT) setup to characterize additively manufactured (AM) components for process parameter optimization and alloy qualification. Two build plates were fabricated, each containing one hundred and five test coupons manufactured under systematically varied laser power, scan speed, and hatch spacing. XCT scans were performed using a ZEISS METROTOM 800 [Zeiss, Oberkochen, DE] system at voxel resolutions between 12-18 μm. Each scan was completed in under 15 minutes using sparse-view acquisition optimized for high-throughput inspection. The acquired projection data were reconstructed. The reconstructed 3D volumes were automatically segmented to identify pores or inclusions, and flaw metrics including equivalent diameter, Feret diameter, sphericity, and spatial distribution were extracted for all samples. These defect metrics were correlated with the applied processing parameters to determine optimal parameter windows for minimizing internal porosity and maximizing mechanical consistency. The automated workflow enabled full characterization of hundreds of samples within a few days and significantly accelerated the identification and qualification of the new alloy system.

Thermal diffusivity was measured by the xenon flash method using a Netzsch LFA 457 [Netzsch, Selb, DE]. Graphite-coated specimens (12.7 mm diameter, 1.5 mm thick) were tested in 50° C. increments up to 600° C. during heating under ultra-high purity argon (100 mL/min).

The specific heat capacity was measured continuously up to 600° C. by using a Netzsch differential scanning calorimeter (DSC) [Netzsch, Selb, DE]. Specific heat capacity (Cp) is obtained following the ASTM Designation E1269. The DSC is used in argon purging gas environment. The specimen is 5.5-6.0 mm in diameter and 1.0 mm in thickness. Two sets of Pt/Rh crucibles with lids are placed in the reference and sample positions. At least two baseline runs with empty pans are needed to confirm there is no shift. In the reference run, a sapphire standard is placed in the sample position while the reference pan is empty. Subsequent sample runs will follow the same heating/cooling schedules, which is typically 10-20K per minute. Cp calculation follows the E1269 using the known Cp values of the sapphire and a ratio method.

Rockwell C hardness (HRC) measurements were made using a Wilson 2000 [Buehler, Binghamton] tester under a 150 kg load.

Tensile testing was used to demonstrate ambient elevated temperature 0.2% offset yield strength and ultimate tensile strength (UTS) at temperatures ranging from 25 to 650° C. in accordance with ASTM E8/21. Tensile specimens were sub-sized with a 25.4 mm overall length, 7.62 mm gage length, 1.52 mm gage width, and 0.76 mm gage thickness. All tensile samples of the invention alloys were machined from cast ingots that had been solution treated and aged. Tensile specimens from H13 were machined from commercial wrought H13, with the long axis of the tensile specimen along the rolling direction/extrusion, and or long axis of the bar. The tests were conducted under quasi-static conditions, with an initial engineering strain rate of 0.001 s⁻¹. 0.2% offset yield and UTS values are averages of two tests per condition.

Charpy impact testing was conducted in accordance with ASTM E23 to evaluate the impact toughness of the invention alloys at ambient and elevated temperatures of 25° C. and 400° C. Full-size Charpy V-notch (CVN) specimens were machined in the longitudinal direction from hot rolled plates of the invention alloys that had been solution treated and aged. The specimens had an overall length of 55 mm, a width of 10 mm, and a thickness of 10 mm. The V-notch had a depth of 2 mm), and a notch angle of 45°. Elevated-temperature Charpy impact testing was performed using a automated transfer system, which mechanically transfers specimens from a temperature-controlled environmental chamber to the impact testing platform within five seconds, consistent with ASTM E23 requirements.

Cu content: Cu ranges from 1.75 to 5 wt. % in the developed alloys. Cu contributes to ambient temperature corrosion resistance in the invention alloys. Enhanced corrosion resistance is important for dies fabricated by AM which contain conformal cooling channels to reduce corrosion forming within the cooling channels. Cu can also improve the oxidation resistance as well when alloyed with Fe in conjunction with Mn, Si, and/or Cr.

Cu also provides an important austenite stabilizing effect in the invention alloys. Of substitutional austenite stabilizing elements Ni, Mn, and Cu, Cu has the weakest reducing effect on the Ae1 temperature, whereas Ni and Mn have a relatively strong effect on reducing the Ae1 temperature. This is important in order to stabilize the high temperature austenite phase at solution treatment temperatures while also not excessively lowering the Ae1 temperature of the steel. In addition, Cu has relatively high solubility in the austenite phase of steel, but relatively low solubility in ferrite/martensite. This phenomenon is exploited in the present invention. Upon solution treating, quenching, and aging at sufficiently high temperatures, the invention alloys undergo age hardening. One of the age hardening mechanisms is the precipitation of Cu precipitates. The fine-scale Cu particles which precipitate in the steel after heat treatment contribute to strength but do not degrade the thermal conductivity, in part because the precipitates themselves are nearly pure Cu and have high thermal conductivity. The high thermal conductivity of the Cu precipitates counteracts the increased interfacial thermal resistance arising from the interfaces between the Cu particles and matrix. In addition, the low solubility of Cu in martensite/ferrite results in relatively low amounts of Cu remining in the matrix of the steel after aging, which also contributes to improved thermal conductivity by reducing electron and phonon scattering sites in the matrix by depleting Cu from the solid solution.

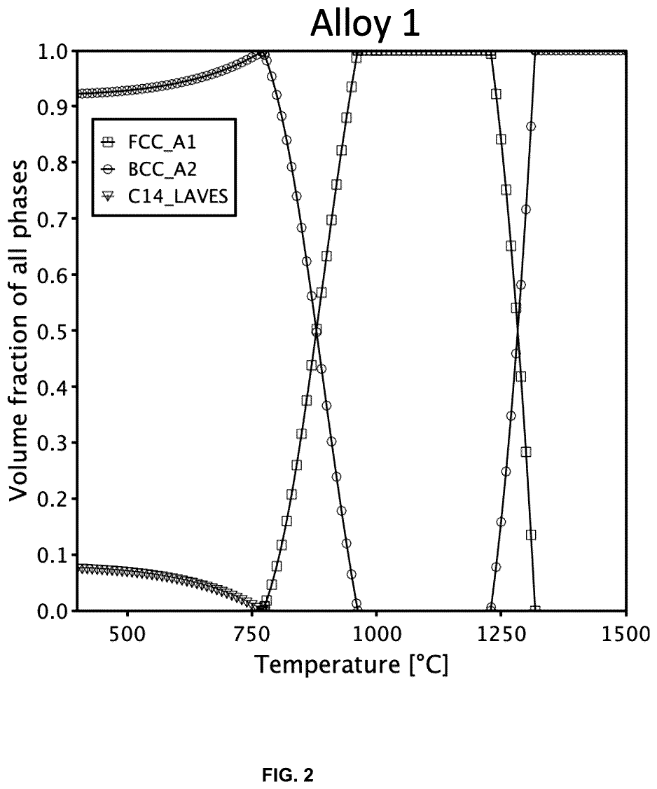

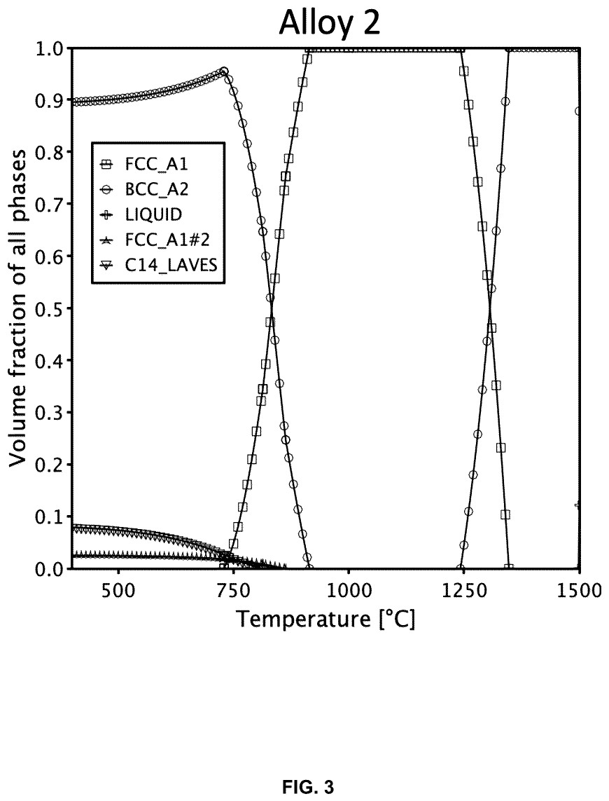

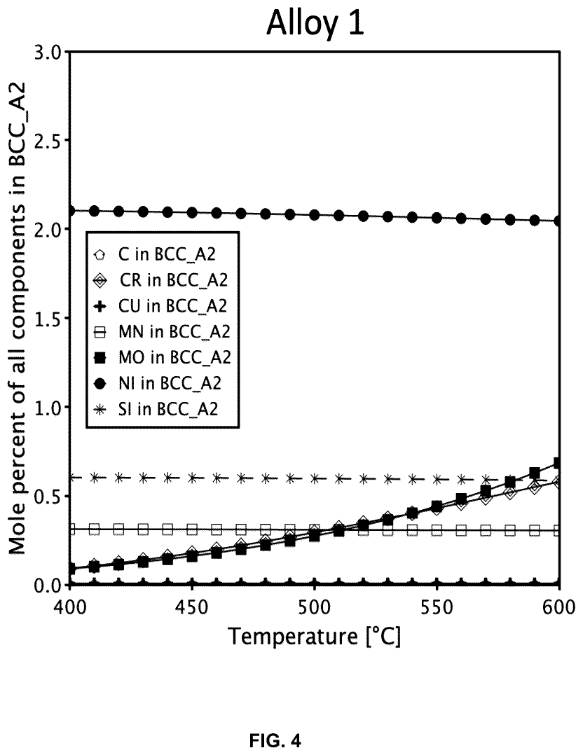

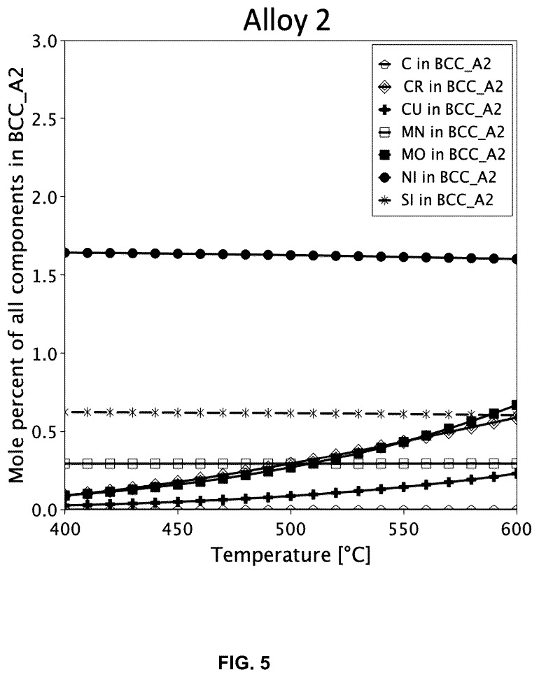

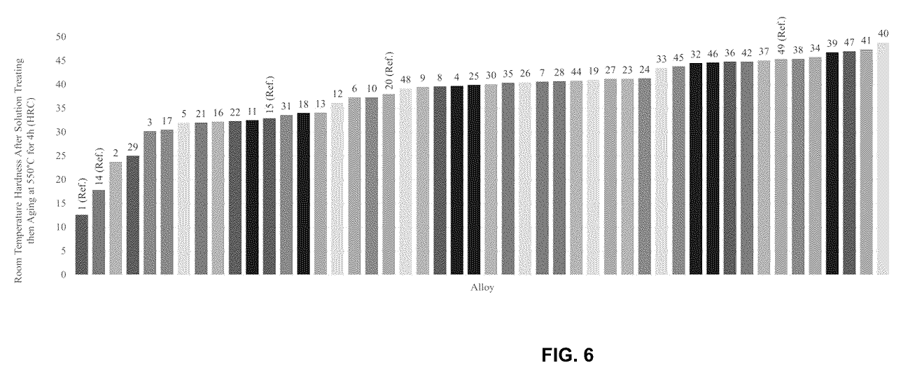

FIGS. 2 and 3 show the predicted equilibrium phase fractions of reference alloy 1 and invention alloy 2, respectively. In addition, FIGS. 4 and 5 show the predicted equilibrium composition of the body centered cubic (BCC) matrix phase of alloys 1 and 2, respectively. The compositions of alloys 1 and 2 are nominally similar, but alloy 1 contains a slightly higher Ni content compared to alloy 2 (2.05 vs 1.58 wt. %) while alloy 2 contains 2.81 wt. % Cu vs only trace amounts in alloy 1. The phase equilibria shows that alloy 2 has a wider temperature range for austenitization compared to alloy 1, despite lower amounts of Ni content, illustrating the beneficial austenite stabilizing impact of Cu. In addition, despite the addition of 2.81 wt. % Cu to alloy 2, the predicted Ae1 temperature of the steel still remains relatively high at 728° C. In addition, in FIGS. 4 and 5, the amount of Ni in solid solution in the matrix is predicted to be relatively high for alloys 1 and 2, while the amount of Cu in the BCC/martensite matrix at equilibrium is predicted to be relatively low, due to low solubility, which is beneficial for thermal conductivity. FIG. 6 shows that all of the Cu containing invention alloys which are austenitized and water quenched show an increase in hardness after aging at 550° C. for 4 h. Notably, reference alloy 1, which contains no intentionally added Cu, shows no age hardening response after aging at 550° C. for 4 h (Table 6).

TABLE 6
Solution treatment temperature and time, hardness at room temperature in as-solution treated condition
and as-solution treated plus aged at 550° C. for 4 h, the hardening increment (difference between
solution treated hardness and solution treated plus aged 550C for 4 h hardness), and the strength factor.

| | | | Hardness after | | |
|---|---|---|---|---|---|
| | | | Solution Treating | Hardening | |
| | Solution Treatment | Solution Treated | and Aging | Increment | Strength |
| Alloy | Temperature/Time | Hardness (HRC) | 550° C./4 h (HRC) | (HRC) | Factor |
| 1 (Ref.) | 1000° C./1 h | 16.9 | 12.6 | −4.3 | 14.8 |
| 2 | 1000° C./1 h | 23.5 | 23.8 | 0.3 | 23.7 |
| 3 | 1065° C./1 h | 26.5 | 30.2 | 3.7 | 31.3 |
| 4 | 1065° C./1 h | 30.6 | 39.7 | 9.1 | 39.9 |
| 5 | 1065° C./1 h | 30.8 | 32 | 1.2 | 32.4 |
| 6 | 1065° C./1 h | 29.2 | 37.3 | 8.1 | 37.2 |
| 7 | 1065° C./1 h | 32.1 | 40.6 | 8.5 | 40.3 |
| 8 | 1065° C./1 h | 32.1 | 39.6 | 7.5 | 39.6 |
| 9 | 1120° C./1 h | 28.1 | 39.5 | 11.4 | 40.0 |
| 10 | 1065° C./1 h | 24.7 | 37.3 | 12.6 | 37.8 |
| 11 | 1065° C./1 h | 26.6 | 32.5 | 5.9 | 31.9 |
| 12 | 1065° C./1 h | 28.3 | 36.2 | 7.9 | 34.8 |
| 13 | 1065° C./1 h | 26.9 | 34.1 | 7.2 | 33.5 |
| 14 (Ref.) | 1150° C./4 h + 1065° C./1 h | 95.5 (HRB) | 95 (HRB) | −0.5 (HRB) | 18.0 |
| 15 (Ref.) | 1150° C./4 h + 1065° C./1 h | 26.2 | 32.9 | 6.7 | 33.9 |
| 16 | 1065° C./1 h | 23.2 | 32.2 | 9.0 | 30.9 |
| 17 | 1065° C./1 h | 23.8 | 30.5 | 6.7 | 32.2 |
| 18 | 1065° C./1 h | 28.7 | 34 | 5.3 | 29.9 |
| 19 | 1065° C./1 h | 31.9 | 40.7 | 8.8 | 44.8 |
| 20 (Ref.) | 1160° C./1 h | 31.6 | 38 | 6.4 | 36.9 |
| 21 | 1065° C./1 h | 29.03 | 32 | 3.0 | 30.9 |
| 22 | 1065° C./1 h | 30.2 | 32.3 | 2.1 | 29.6 |
| 23 | 1065° C./1 h | 30.4 | 41.2 | 10.8 | 37.3 |
| 24 | 1065° C./1 h | 30.8 | 41.3 | 10.5 | 37.8 |
| 25 | 1065° C./1 h | 29.6 | 39.9 | 10.3 | 41.6 |
| 26 | 1065° C./1 h | 27.5 | 40.5 | 13.0 | 41.7 |
| 27 | 1065° C./1 h | 30.0 | 41.2 | 11.2 | 41.4 |
| 28 | 1065° C./1 h | 27.1 | 40.7 | 13.6 | 38.0 |
| 29 | 1065° C./1 h | 26.1 | 25 | −1.1 | 26.9 |
| 30 | 1065° C./1 h | 27.3 | 40.1 | 12.8 | 41.6 |
| 31 | 1065° C./1 h | 25.9 | 33.6 | 7.7 | 33.9 |
| 32 | 1065° C./1 h | 28.7 | 44.5 | 15.8 | 44.3 |
| 33 | 1065° C./1 h | 29.8 | 43.5 | 13.7 | 44.1 |
| 34 | 1065° C./1 h | 31.9 | 45.8 | 13.9 | 45.0 |
| 35 | 1065° C./1 h | 27.3 | 40.4 | 13.1 | 42.7 |
| 36 | 1065° C./1 h | 27.7 | 44.8 | 17.1 | 47.8 |
| 37 | 1065° C./1 h | 27.9 | 45.1 | 17.2 | 44.7 |
| 38 | 1065° C./1 h | 29.4 | 45.4 | 16.0 | 44.4 |
| 39 | 1065° C./1 h | 32.2 | 46.78 | 14.6 | 46.3 |
| 40 | 1065° C./1 h | 34.2 | 48.9 | 14.7 | 48.5 |
| 41 | 1065° C./1 h | 29.7 | 47.4 | 17.7 | 42.7 |
| 42 | 1065° C./1 h | 27.9 | 44.8 | 16.9 | 44.0 |
| 43 | 1065° C./1 h | 28 | 47 | 19.0 | 47.8 |
| 44 | 1065° C./1 h | 30.9 | 40.8 | 9.9 | 39.9 |
| 45 | 1065° C./1 h | 39 | 43.8 | 4.8 | 45.3 |
| 46 | 1065° C./1 h | 30.3 | 44.6 | 14.3 | 43.8 |
| 48 | 1065° C./1 h | 26.7 | 39.2 | 12.5 | 35.5 |
| 49 (Ref.) | 1065° C./1 h | 27.5 | 45.4 | 17.9 | 55.2 |
| M300 | 1065° C./1 h | 32.7 | 51 | 18.3 | 50.8 |

C content: The alloys contain relatively low C content of 0.1 wt. % or below in comparison to H13, that contains nominally 0.4 wt. % C, to promote improved printability relative to H13. A C content equal to or less than 0.1 wt. % can reduce hardness and increase toughness and ductility in the as printed condition, increasing resistance to cracking and overall printability.

N content: N is a strengthening element in steel. It typically manifests in nitrides or carbonitrides of V and Cr. Too much N can cause embrittlement and can excessively lower the martensite start temperature in the present steels, resulting in incomplete transformation to martensite during quenching. The bulk N content of the alloy or powder feedstock may be up to and including 0.1 wt. %. Additional N may be picked up during printing and/or the steel surface may be locally enriched in N beyond 0.1 wt. % by processes such as nitriding or carbo-nitriding.

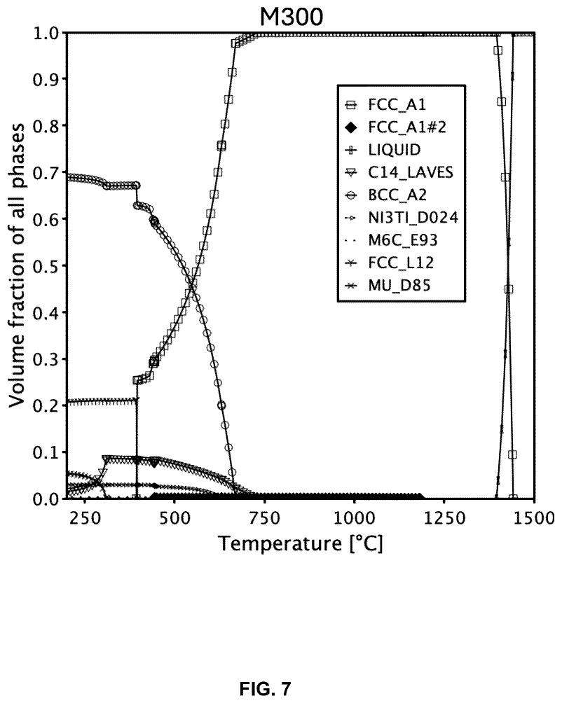

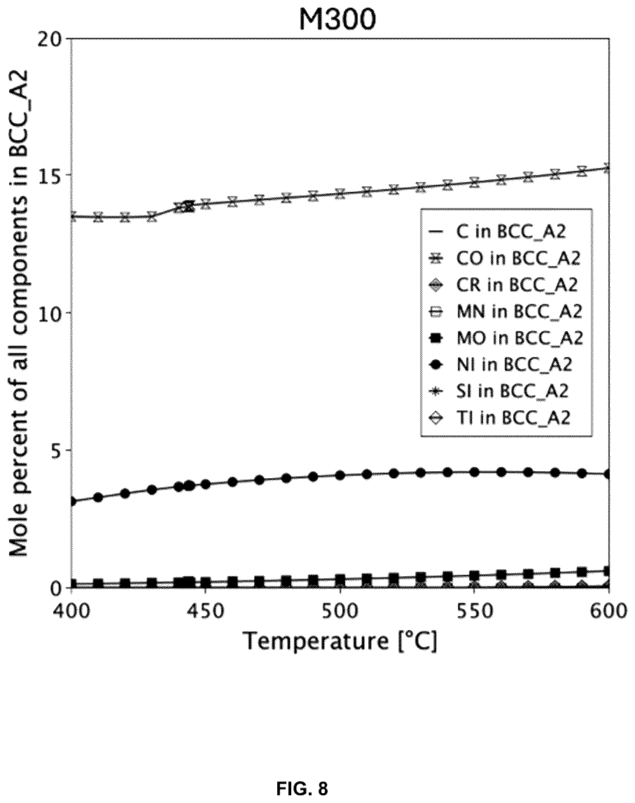

Ni content: Ni ranges from 0 to 4.25 wt. % in the present alloys. Ni can be omitted from the alloy. Ni is an austenite stabilizer. Ni has advantages as an austenite stabilizer in the invented alloys relative to Mn. Ni provides enhanced austenite stabilization at higher temperatures to ensure the alloys can be fully austenitized at higher temperatures while not having as strong a reducing impact on the Ae1 temperature as Mn. The latter is important in order to keep the Ae1 temperature of the invented alloys high enough to minimize the tendency for phase transformation or austenite reversion during elevated temperature service. However, using excessive amounts of Ni can result in a low Ae1 temperature and austenite reversion during service. Commercial alloy M300 contains extensive amounts of Ni (nominally 18 wt. %), and the phase equilibria of M300 in shown in FIG. 7 shows a relatively low Ae1 temperature near 404° C. Such a low Ae1 temperature leads to undesirable austenite reversion during service. FIG. 8 shows the equilibrium composition of the BCC matrix of M300, which contains significant amounts of Ni and Co.

Co content: Co can be added to the invention alloys up to and including 6 wt. %. The addition of Co can widen the austenitization window to higher temperatures without significantly changing the Ae1 temperature and also suppress the formation of delta ferrite. Co can stabilize the austenite phase to reduce the presence of delta ferrite in the as-printed microstructure.

Si content: Si levels are between 0 and 2.1 wt. %. in the disclosed alloys. Si significantly enhances the strength of the alloys by enhancing the age-hardening response by facilitating the precipitation of Fe—Mo rich intermetallics in the present alloys. For instance, alloys 29, 31, 28, 32, and 34 contain similar compositions but with Si contents of <0.01, 0.45, 0.92, 1.62, and 2.07 wt. %, respectively, resulting in hardnesses after ST+A of 25, 33.6, 40.7, 44.5, and 45.8 HRC (see Table 6) respectively. Additions of Si also modestly lower the thermal conductivity at elevated temperatures of 300 to 600° C. Si can reduce oxidation kinetics, improve corrosion resistance, raise the Ae1 temperature, reduce the martensite start (Ms) temperature, and provides solid solution hardening.

Cr content: Cr content ranges from 0 to 6 wt. % in the disclosed alloys. Cr improves oxidation and corrosion resistance in the invented alloys. Cr has an undesirable effect of reducing the thermal conductivity of the steel, which can lead to less effective cooling in die applications, higher temperatures and reduced fatigue performance, and longer cycle times in service.

Mo content: Mo is added in the amount of 1.9 to 8 wt. %. Mo has a smaller reducing influence on the high temperature austenite stability, which enables relatively large additions of Mo without the need for excessive amounts of austenite stabilizing elements, which can reduce the HTF and the ARF. Mo also has relatively low solubility in martensite/ferrite, and precipitates out in Fe and Mo rich intermetallics, which is beneficial for thermal conductivity.

W content: W can be added in addition or as a replacement for Mo. W reduces the coarsening rate of intermetallics. W is added in the amount of 0 to 7 wt. %. W forms intermetallics for strengthening.

Ti content: Ti ranges from 0-1.6 wt. % in the disclosed alloys. Ti has shown to significantly improve strength and refine grain size, particularly in combination with C. Ti can combine with Ni to form intermetallics to improve strength after age hardening. Too much Ti causes ferrite stabilization and loss of high temperature austenite stabilization.

Nb content: Nb ranges from 0.0-1 wt. % in the disclosed alloys. Nb forms intermetallics and carbides in the disclosed alloys to improve strength. Nb significantly increases the dissolution temperature of the intermetallics in the invention alloys.

Mn content: Mn can be added up to 1 wt. % in the disclosed alloys or omitted from the alloy entirely. Mn strongly reduces the Ms temperature and the Ae1 temperature and ARF. The reduction in Ae1 temperature can result in transformation of martensite/ferrite to austenite at low temperatures in service. Mn is kept below 1 wt. %. Mn also strongly reduces the thermal conductivity of the steel. Mn also improves strength via solid solution hardening and hardenability. Mn can improve oxidation resistance.

Boron content: B can be added up to 0.005 wt. % to promote hardenability. B above 0.005 wt. % can result in embrittlement.

Aluminum content: Al can be added up to 1 wt. % to promote oxidation resistance, solid solution hardening, and improve the response to nitriding. Too much Al can reduce the high temperature austenite stability such that fully austenitizing the material is not possible.

The strength of the invention alloys in the aged condition is strongly influenced by composition. The room temperature hardness after ST at 1065° C. for 1 h, water quenching, and aging at 550° C. for 4 h can be related to the composition by the Strength Factor, again defined as:

$$S F = - 1 5.1 - 0.39 {Ni}_{wt . \%} + 0.95 {Mn}_{wt . \%} + 75.2 {C}_{wt . \%} + 2.29 {Cr}_{wt . \%} + 11.6 {Si}_{wt . \%} + 5.93 {Mo}_{wt . \%} + 2.91 {Cu}_{wt . \%} + 10.3 {Ti}_{wt . \%} + 26.8 {Nb}_{wt . \%} + 2.54 {W}_{wt . \%} + 0.78 {Co}_{wt . \%} + 9. {Al}_{wt . \%} + 0.48 ( {Mo}_{wt . \%} - 4.58 ) ( {Mo}_{wt . \%} - 4.58 ) - 2.56 ( {Si}_{wt . \%} - 0.65 ) ( {Si}_{wt . \%} - 0.65 ) - 37.1 ( {Nb}_{wt . \%} - 0.09 ) + 2.67 ( {Mo}_{wt . \%} - 4.58 ) ( {Si}_{wt . \%} - 0.65 ) + 4. ( {Ni}_{wt . \%} - 2.95 ) ( {Ti}_{wt . \%} - 0.12 ) + 0.0 \; 08 ( {Ni}_{wt . \%} - 2.95 ) ( {Mo}_{wt . \%} - 4.58 ) .$$

Table 6 shows the strength of each alloy in the ST and ST+A conditions, along with the increase in hardness during aging (hardening increment), and Strength Factor.

FIG. 6 shows the room temperature hardness after ST at 1065° C. for 1 h, water quenching, and aging at 550° C. for 4 h for each alloy in Table 4 along with ranges of strength factors. The invention alloys exhibit strength factors ranging from 23 to 50. Alloys with strength Factors ranging from 37.8 to 48 generally have room temperature hardness values at or exceeding 38 HRC.

Table 7 shows the 0.2% offset yield strength and ultimate tensile strength (UTS) at 25, 400, 550, and 600° C. for invention alloys 29, 28, 7 and commercial alloy H13. This data demonstrates that the invention alloys can achieve high levels of elevated temperature strength. Alloys 7 and 28 both exhibit 0.2% offset yield strength values greater than 700 MPa at 550° C.

TABLE 7
0.2% Offset yield strength and ultimate tensile strength (UTS) at 25, 400, 550, and 600 for select invention
alloys and H13. The H13 tensile properties in this table were obtained from commercial wrought H13 after
the H13 was solution treated at 1121° C. for 0.5 h, air cooled, tempered at 550° C. for 2
h, air cooled to room temperature, then tempered at 650° C. for 2 h, and cooled to room temperature.

| | 29 | | 28 | | 7 | | H13 | |
|---|---|---|---|---|---|---|---|---|
| | 0.2% Offset | Ultimate | 0.2% Offset | Ultimate | 0.2% Offset | Ultimate | 0.2% Offset | Ultimate |
| | Yield | Tensile | Yield | Tensile | Yield | Tensile | Yield | Tensile |
| Temperature | Strength | Strength | Strength | Strength | Strength | Strength | Strength | Strength |
| (° C.) | (MPa) | (MPa) | (MPa) | (MPa) | (MPa) | (MPa) | (MPa) | (MPa) |
| 25 | 832 | 876 | 1155 | 1333 | 1100 | 1264 | 1161 | 1379 |
| 400 | 651 | 698 | 931 | 1035 | — | — | 899 | 1119 |
| 550 | 559 | 586 | 760 | 792 | 727 | 759 | 766 | 849 |
| 600 | — | — | — | — | 628 | 657 | 633 | 710 |

Table 8 shows the Charpy impact toughness at 25° C. and 400° C. for invention alloys 28, 29, 34-37, 33, and 44. At 25° C., the invention alloys exhibit impact energies ranging from approximately 7.9 J to 21.3 J. At 400° C., alloys 28 and 29 demonstrate a substantial increase in impact energy with values exceeding 75 J. This data indicates that the invention alloys can achieve high levels of impact toughness.

TABLE 8
Charpy impact energy of selected invention alloys measured
at 25° C. and 400° C. The invention alloys were
solution treated at 950° C., 1000° C., or 1065°
C. as specified, then water quenched and aged at 550°
C. for 4 h. The table also includes the corresponding hardness
value of the 25° C. Charpy specimen.

| | |
|---|---|
| Impact Toughness (J) | Hardness |

| | | | |
|---|---|---|---|
| Alloy | 25° C. | 400° C. | (HRC) |

| | | | | |
|---|---|---|---|---|
| 28 | (1065° C.) | 15.1 | 77.8 | 40.2 |
| 29 | (1065° C.) | 7.88 | 82.3 | 24.9 |
| 34 | (1000° C.) | 9.95 | — | 41.8 |
| 35 | (1000° C.) | 14.73 | — | 40.2 |
| 35 | (950° C.) | 21.28 | — | 37.1 |
| 36 | (1000° C.) | 17.54 | — | 42.5 |
| 37 | (950 C) | 11.75 | — | 42.1 |
| 33 | (1000° C.) | 14.15 | — | 41.9 |
| 44 | (1000° C.) | 16.5 | — | 40.7 |

Softening due to long term thermal exposure is a challenge for tool steels. Table 9 shows the solution treated hardness, the ST+A hardness, and the solution treated+aged+thermally soaked hardness of select invention alloys. The hardness after thermal soaking for 500 h at 550° C. simulates softening during in-service exposure to high temperatures. All invention alloys in Table 9 (7, 28, 30-34, 36-46) exhibit between 1 to 10 HRC greater hardness than H13 after long term thermal soaking, with the exception of alloy 29, which does not contain significant Si content. The invention alloys of Table 9 have a hardness after long term thermal soaking at 550 C for 500 h that is equal to or exceeds 32 HRC, with the exception of alloy 29.

TABLE 9
Hardness in the solution treated + aged condition (ST + A) and
solution treated + aged+ thermally soaked condition (ST +
A + TS). For invention alloys 7, 28-34, 36-46, ST + A =
1065° C./1 h WQ (water quenched) + 550° C./4 h, and ST +
A + TS = 1065° C./1 h WQ + 550° C./4 h + 550°
C./500 h. For H13, ST + A = 1010° C./1 h followed by oil
quenching (OQ) then double tempering at 595° C./2 h + 595°
C./2 h and ST + A + TS = 1010° C./1 h followed by oil
quenching (OQ) then double tempering at 595° C./2 h+595° C./2
h + 550° C./500 h. For M300 ST + A = 816° C./1
h WQ + 600° C./4 h and ST + A + TS = 816°
C./1 h WQ + 600° C./4 h + 550° C./500 h

| | Solution | Solution Treated + | |
|---|---|---|---|
| | Treated + | Aged + Thermally Soaked | Hardness Change |
| | Aged (ST + A) | (ST + A + TS) | During Soaking |
| Alloy | Hardness (HRC) | Hardness (HRC) | (HRC) |
| 7 | 40.6 | 32.15 | −8.45 |
| 7 | 46* | 41** | −5 |
| 28 | 40.7 | 34.2 | −6.5 |
| 29 | 25 | 25.8 | 0.8 |
| 30 | 43.5 | 36.5 | −7 |
| 31 | 33.6 | 34.1 | 0.5 |
| 32 | 44.5 | 36.9 | −7.6 |
| 33 | 43.5 | 36.5 | −7 |
| 34 | 45.8 | 36.8 | −9 |
| 36 | 44.8 | 37.2 | −7.6 |
| 37 | 45.1 | 37.2 | −7.9 |
| 38 | 45.4 | 37.6 | −7.8 |
| 39 | 46.78 | 39.2 | 7.6 |
| 40 | 48.9 | 41.6 | −7.3 |
| 41 | 47.4 | 35.7 | −11.7 |
| 42 | 44.8 | 38.6 | −6.2 |
| 43 | 47 | 41 | −6 |
| 44 | 40.8 | 35.1 | −5.7 |
| 45 | 43.8 | 36.2 | −7.6 |
| 46 | 44.6 | 36.6 | −8.4 |
| H13 | 46.0 | 31.0 | −15 |
| M300 | 43.9 | 39.9 | −4 |

*Hardness values are after laser melting and rapid solidification and aging for 4 h at 550° C.
**Hardness values are after laser melting and rapid solidification and aging for 4 h at 550° C., followed by an additional 500 h at 550 C°.

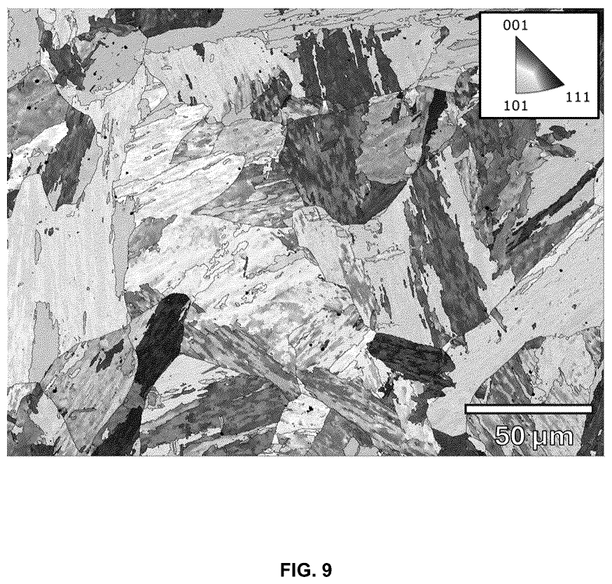

Alloy 7 was used to demonstrate the impact of laser melting and rapid solidification on cracking and the age hardening response. For this, the cast ingot of alloy 7 was austenitized at 1065° C. for 1 h, quenched in water, sectioned, and polished. A laser was subsequently traversed across the polished surface of the alloy to remelt the steel and rapidly solidify it. No significant cracks were observed in the microstructure of the laser re-melted material. The laser melted and rapidly solidified material was then age hardened for 4 h at 550° C., yielding a martensitic microstructure with starting hardness of 46 HRC. This hardness is 5.4 HRC greater than the hardness of the conventionally cast, solution treated, and aged alloy 7, as shown in Table 9. The martensitic microstructure in the laser melted and rapidly solidified and aged condition is shown in the electron backscatter diffraction (EBSD) inverse pole figure (IPF) map in FIG. 9. Laser melted alloy 7 was then long term thermally soaked for 500 h at 550° C., resulting in a reduction in hardness to approximately 41 HRC. Notably, this hardness exceeds the hardness of M300 after long term thermal soaking at 550° C. for 500 h, as shown in Table 9.

The invention alloys may be printed by additive manufacturing to enable fabrication of complex geometries. Table 10 shows the porosity of numerous parts printed from alloy 47 by LPBF with different printing parameters, laser power (P), scan velocity (v), hatch spacing (h), and layer thickness (t). From these parameters, the volumetric energy density (VED) may be calculated by the following equation:

$$V E D = \frac{P}{ν h t}$$

The printing demonstration shows Alloy 47 may be printed with porosity less than 0.1 vol. %, which is a typical limit for additively manufactured parts in critical structural applications, when printed using the parameters in Table 10, and even below 0.05% for select parameters as indicated in Table 10. Table 11 shows the hardness of selected printed materials in the as-printed, as-printed plus solution treated, and as-printed plus solution treated plus aged conditions for select printing parameters, as well as hardness increment (increase in hardness after aging relative to the solution treated condition). The as-built hardness is relatively low to reduce brittleness, and the alloy may be solution treated at 1000° C. or 1065° C. for 1 h or other suitable temperatures, quenched in water, oil, forced air, still air, or other suitable quenching medium, and aged at 550° C. for 4 h to achieve hardnesses ranging from approximately 41 to 42 HRC.

TABLE 10
Additive manufacturing printing parameters power (P), scan velocity (v), hatch
spacing (h), and volumetric energy density and resulting porosity in vol.
%. Parameters which yield a vol. % of porosity below 0.1% are indicated.

| Parameter | | | Hatch | VED | | Porosity | Porosity ≤ |
|---|---|---|---|---|---|---|---|
| No. | Power(W) | Velocity(mm/s) | (mm) | (J/mm³) | P/V | (%) | 0.1% |
| 209 | 227.5 | 700 | 0.12 | 90.28 | 0.33 | 0.0183 | Yes |
| 210 | 195.0 | 600 | 0.12 | 90.28 | 0.33 | 0.0151 | Yes |
| 212 | 97.5 | 300 | 0.12 | 90.28 | 0.33 | 11.2433 | No |
| 259 | 227.5 | 700 | 0.12 | 90.28 | 0.33 | 0.015 | Yes |
| 260 | 195.0 | 600 | 0.12 | 90.28 | 0.33 | 0.0129 | Yes |
| 262 | 97.5 | 300 | 0.12 | 90.28 | 0.33 | 6.18 | No |
| 208 | 292.5 | 900 | 0.12 | 90.28 | 0.33 | 0.0403 | Yes |
| 211 | 162.5 | 500 | 0.12 | 90.28 | 0.33 | 0.0718 | Yes |
| 258 | 292.5 | 900 | 0.12 | 90.28 | 0.33 | 0.0396 | Yes |
| 261 | 162.5 | 500 | 0.12 | 90.28 | 0.33 | 0.0739 | Yes |
| 213 | 243.8 | 900 | 0.1 | 90.28 | 0.27 | 0.0716 | Yes |
| 263 | 243.8 | 900 | 0.1 | 90.28 | 0.27 | 0.0337 | Yes |
| 214 | 189.6 | 700 | 0.1 | 90.28 | 0.27 | 0.0574 | Yes |
| 217 | 195.0 | 900 | 0.08 | 90.28 | 0.22 | 0.0768 | Yes |
| 218 | 151.7 | 700 | 0.08 | 90.28 | 0.22 | 0.0549 | Yes |
| 268 | 151.7 | 700 | 0.08 | 90.28 | 0.22 | 0.0095 | Yes |
| 219 | 108.3 | 500 | 0.08 | 90.28 | 0.22 | 0.4042 | No |
| 269 | 108.3 | 500 | 0.08 | 90.28 | 0.22 | 2.1534 | No |
| 215 | 135.4 | 500 | 0.1 | 90.28 | 0.27 | 0.0841 | Yes |
| 216 | 81.3 | 300 | 0.1 | 90.28 | 0.27 | 12.0397 | No |
| 224 | 262.5 | 900 | 0.1 | 97.22 | 0.29 | 0.0337 | Yes |
| 227 | 210.0 | 900 | 0.08 | 97.22 | 0.23 | 0.0263 | Yes |
| 305 | 210.0 | 600 | 0.12 | 97.22 | 0.35 | 0.0667 | Yes |
| 228 | 163.3 | 700 | 0.08 | 97.22 | 0.23 | 0.0141 | Yes |
| 225 | 204.2 | 700 | 0.1 | 97.22 | 0.29 | 0.0167 | Yes |
| 229 | 116.7 | 500 | 0.08 | 97.22 | 0.23 | 0.2093 | No |
| 226 | 145.8 | 500 | 0.1 | 97.22 | 0.29 | 0.0209 | Yes |
| 223 | 105.0 | 300 | 0.12 | 97.22 | 0.35 | 9.4076 | No |
| 273 | 105.0 | 300 | 0.12 | 97.22 | 0.35 | 4.7182 | No |
| 220 | 315.0 | 900 | 0.12 | 97.22 | 0.35 | 0.0335 | Yes |
| 221 | 245.0 | 700 | 0.12 | 97.22 | 0.35 | 0.0613 | Yes |
| 222 | 175.0 | 500 | 0.12 | 97.22 | 0.35 | 0.1162 | No |
| 270 | 315.0 | 900 | 0.12 | 97.22 | 0.35 | 0.0333 | Yes |
| 271 | 245.0 | 700 | 0.12 | 97.22 | 0.35 | 0.0128 | Yes |
| 272 | 175.0 | 500 | 0.12 | 97.22 | 0.35 | 0.1129 | No |
| 234 | 270 | 900 | 0.08 | 125.0 | 0.3000 | 0.0352 | Yes |
| 238 | 157.5 | 700 | 0.06 | 125.0 | 0.2250 | 0.0204 | Yes |
| 235 | 210 | 700 | 0.08 | 125.0 | 0.3000 | 0.0265 | Yes |
| 239 | 112.5 | 500 | 0.06 | 125.0 | 0.2250 | 6.9237 | No |
| 230 | 337.5 | 900 | 0.1 | 125.0 | 0.3800 | 0.0384 | Yes |
| 231 | 262.5 | 700 | 0.1 | 125.0 | 0.3750 | 0.0177 | Yes |
| 232 | 187.5 | 500 | 0.1 | 125.0 | 0.3750 | 0.1543 | No |
| 236 | 150 | 500 | 0.08 | 125.0 | 0.3000 | 0.1616 | No |
| 233 | 112.5 | 300 | 0.1 | 125.0 | 0.3750 | 1.1209 | No |
| 237 | 202.5 | 900 | 0.06 | 125.0 | 0.2250 | 0.0303 | Yes |
| 249 | 189 | 700 | 0.06 | 150.0 | 0.27 | 0.0223 | Yes |
| 250 | 135 | 500 | 0.06 | 150.0 | 0.27 | 2.727 | No |
| 299 | 189 | 700 | 0.06 | 150.0 | 0.27 | 0.0265 | Yes |
| 300 | 135 | 500 | 0.06 | 150.0 | 0.27 | 4.005 | No |
| 301 | 189 | 700 | 0.06 | 150.0 | 0.27 | 0.0222 | Yes |
| 303 | 189 | 700 | 0.06 | 150.0 | 0.27 | 0.0238 | Yes |
| 248 | 243 | 900 | 0.06 | 150.0 | 0.27 | 0.0553 | Yes |
| 298 | 243 | 900 | 0.06 | 150.0 | 0.27 | 0.0473 | Yes |
| 240 | 360 | 800 | 0.1 | 150.0 | 0.45 | 0.0303 | Yes |
| 241 | 315 | 700 | 0.1 | 150.0 | 0.45 | 0.0283 | Yes |
| 242 | 225 | 500 | 0.1 | 150.0 | 0.45 | 0.3253 | No |
| 244 | 324 | 900 | 0.08 | 150.0 | 0.36 | 0.0391 | Yes |
| 290 | 360 | 800 | 0.1 | 150.0 | 0.45 | 0.0338 | Yes |
| 292 | 225 | 500 | 0.1 | 150.0 | 0.45 | 0.788 | No |
| 294 | 324 | 900 | 0.08 | 150.0 | 0.36 | 0.0456 | Yes |
| 243 | 135 | 300 | 0.1 | 150.0 | 0.45 | 1.6616 | No |
| 245 | 252 | 700 | 0.08 | 150.0 | 0.36 | 0.035 | Yes |
| 246 | 180 | 500 | 0.08 | 150.0 | 0.36 | 0.2154 | No |
| 293 | 135 | 300 | 0.1 | 150.0 | 0.45 | 3.0041 | No |
| 295 | 252 | 700 | 0.08 | 150.0 | 0.36 | 0.0427 | Yes |
| 296 | 180 | 500 | 0.08 | 150.0 | 0.36 | 0.2702 | No |
| 247 | 108 | 300 | 0.08 | 150.0 | 0.36 | 5.4428 | No |
| 297 | 108 | 300 | 0.08 | 150.0 | 0.36 | 2.4542 | No |

TABLE 11
Hardness of alloy 47 printed by LPBF. Hardness values are in the as-printed condition,
as-printed and solution treated at 1065° C. for 1 h, and as-printed, solution
treated at 1065° C. for 1 h, water quenched, and then aged at 550° C. for 4 h.

| | | | | | | | | Solution | |
|---|---|---|---|---|---|---|---|---|---|
| | | | | | | | | treated | |
| | | | | Volumetric | | | Solution | and | |
| | | Scan | Hatch | Energy | | As-Built | Treated | aged | Hardness |
| Parameter | Power | Velocity | Spacing | Density | Porosity | Hardness | Hardness | hardness | Increment |
| No. | (W) | (mm/s) | (mm) | (J/mm³) | (vol. %) | (HRC) | (HRC) | (HRC) | (HRC) |
| 303 | 189 | 700 | 0.06 | 150.0 | 0.0238 | 29.1 | 25.7 | 41.5 | 15.8 |
| 235 | 210 | 700 | 0.08 | 125.0 | 0.0265 | 30.1 | 27.4 | 41.8 | 14.4 |

The alloys can achieve hardness values equal to or less than 37 HRC in the as-solution treated condition (see Table 6), the as-printed condition (see Table 11), and the as-printed and solution treated condition (see Table 11). The ability to achieve hardnesses equal to or less than 37 HRC can improve resistance to cracking resulting from thermal stresses during printing and also improve machinability.

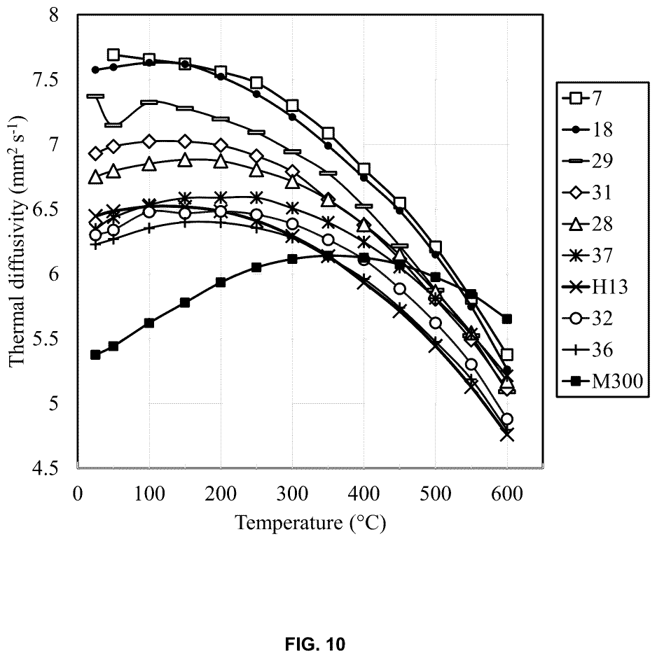

Thermal diffusivity is important for die longevity. Higher thermal diffusivity allows the die to cool more effectively, particularly for dies with conformal cooling channels which can be implemented with AM processes. FIG. 10 and Table 12 shows the thermal diffusivity as a function of temperature for select invention alloys and commercial H13 and M300. It is particularly important to have good heat transfer characteristics in the range of 200-300° C. which is the range of approximate bulk die temperature during high pressure aluminum die-casting. Notably, the invention alloys exhibit a 6.4 to 27.4% greater thermal diffusivity than M300 in the range of 200-300° C.

The enhancement of thermal diffusivity of the invention alloys over M300 is achieved in part by reduced alloy content and limiting the amount and type of atoms in solid solution. The thermal diffusivity may be related to the composition through a Heat transfer factor (HTF):

$$H T F = 7.1 - 0.5 {Mn}_{wt . \%} - 0.32 {Cr}_{wt . \%} - 0.43 {Si}_{wt . \%} - 0.15 ( {Mo}_{wt . \%} + {W}_{wt . \%} + {Nb}_{wt . \%} ) - 0.03 {Co}_{wt . \%} - 0.43 {Al}_{wt . \%} + 3.09 Exp ( - 0 \text{.28} {Ni}_{wt . \%} )$$

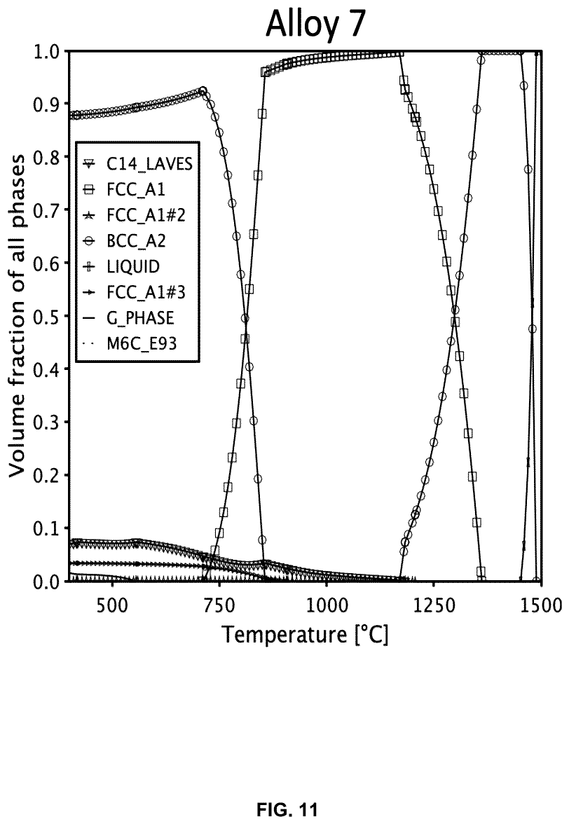

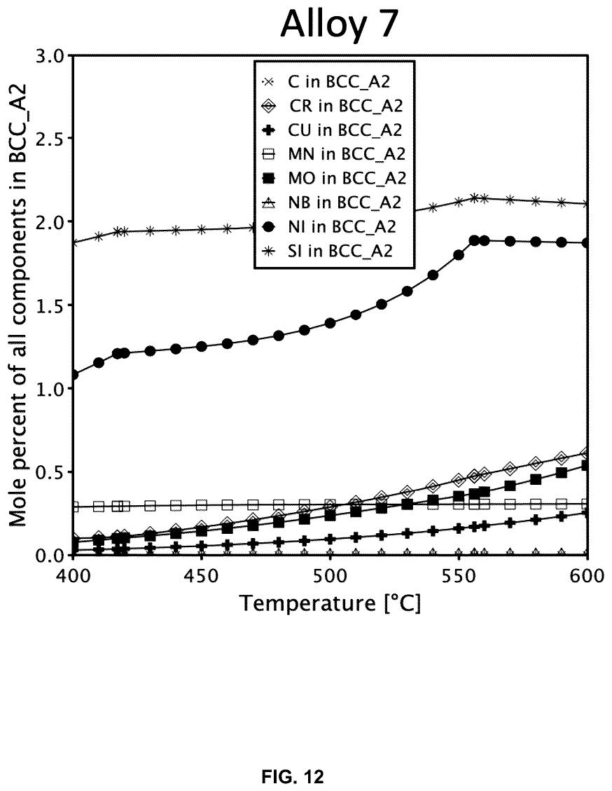

The thermal diffusivity of the disclosed steels is predominately controlled by alloy content in solid solution in ferrite/martensite, and to a lesser extent, the precipitate amounts and types. A novel aspect of the disclosed printable steels is the ability to simultaneously achieve high strength and good thermal diffusivity, without excessive alloy content in solid solution in the ferrite/martensite matrix that will degrade thermal conductivity. Conversely, FIG. 8 shows that M300 is predicted to have approximately 16-18 at. % alloy content in solid solution at equilibrium in the temperature range of 400 to 600° C. (typical aging temperatures for M300). In contrast, the phase equilibria of alloy 7 is shown in FIG. 11 and the predicted amount of solute content in the BCC matrix is shown in FIG. 12. Alloy 7 is predicted to have below 5.5 at. % of alloy content in solid solution in the ferrite/martensite matrix, which contributes to it's better thermal diffusivity as shown in Table 12.

TABLE 12
Thermal diffusivity of invention alloys 7, 28, 29, 31, 32, 36,
and 37 and commercial reference alloys H13 and M300. H13 was
austenitized at 1010° C., air cooled to room temperature.

| Temperature | Thermal Diffusivity (mm² s⁻¹) | | | | | | | | | |
|---|---|---|---|---|---|---|---|---|---|---|
| (° C.) | 7 | 18 | 29 | 31 | 28 | 37 | 32 | H13 | 36 | M300 |
| 25 | — | 7.574 | 7.369 | 6.928 | 6.75 | 6.344 | 6.3 | 6.445 | 6.226 | 5.374 |
| 50 | 7.691 | 7.595 | 7.146 | 6.983 | 6.795 | 6.434 | 6.337 | 6.482 | 6.267 | 5.441 |
| 100 | 7.654 | 7.629 | 7.322 | 7.022 | 6.85 | 6.532 | 6.477 | 6.519 | 6.353 | 5.62 |
| 150 | 7.619 | 7.617 | 7.275 | 7.021 | 6.881 | 6.584 | 6.466 | 6.516 | 6.398 | 5.777 |
| 200 | 7.559 | 7.521 | 7.194 | 6.991 | 6.871 | 6.588 | 6.481 | 6.483 | 6.395 | 5.933 |
| 250 | 7.474 | 7.387 | 7.09 | 6.909 | 6.804 | 6.588 | 6.456 | 6.408 | 6.354 | 6.048 |
| 300 | 7.298 | 7.21 | 6.941 | 6.788 | 6.713 | 6.506 | 6.385 | 6.291 | 6.276 | 6.113 |
| 350 | 7.085 | 6.988 | 6.775 | 6.574 | 6.573 | 6.397 | 6.262 | 6.136 | 6.128 | 6.139 |
| 400 | 6.809 | 6.741 | 6.521 | 6.376 | 6.38 | 6.245 | 6.109 | 5.932 | 5.96 | 6.124 |
| 450 | 6.546 | 6.487 | 6.215 | 6.114 | 6.146 | 6.051 | 5.885 | 5.712 | 5.738 | 6.072 |
| 500 | 6.207 | 6.148 | 5.874 | 5.804 | 5.862 | 5.811 | 5.621 | 5.443 | 5.475 | 5.973 |
| 550 | 5.81 | 5.747 | 5.522 | 5.49 | 5.545 | 5.535 | 5.301 | 5.127 | 5.186 | 5.843 |
| 600 | 5.376 | 5.263 | 5.089 | 5.111 | 5.172 | 5.213 | 4.879 | 4.759 | 4.795 | 5.651 |

Thermal diffusivity, heat capacity, density, and thermal conductivity of invention alloy 7 and commercial alloys H13 and M300 are shown in Table 13. The thermal conductivity of invention alloy 7, M300, and H13 may be calculated from their thermal diffusivity, the density, and the heat capacity. Specifically, the thermal conductivity k is obtained using:

$$k = α ρ {C}_{p}$$

where
α is the thermal diffusivity (m²·s⁻¹),
ρ is the density (kg·m⁻³), and
Cₚ is the specific heat capacity (J·kg⁻¹·K⁻¹).

The density values used in this calculation were obtained from Thermo-Calc.

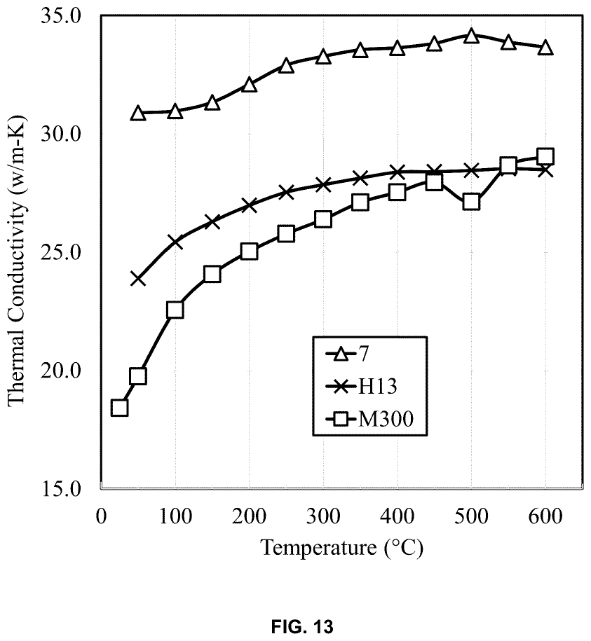

The % improvement in thermal conductivity of invention alloy 7 over M300 ranges from 16 to 56.1% and is shown in parentheses in Table 13. FIG. 13 shows the thermal conductivity as a function of temperature from 25 to 600° C.

TABLE 13
Thermal diffusivity, heat capacity, density, and thermal
conductivity of invention alloy 7 and commercial
alloys H13 and M300. The % improvement of invention
alloy 7 over M300 is shown in parentheses.

| | | | | |
|---|---|---|---|---|
| | Thermal | Heat | | Thermal |
| Temperature | Diffusivity | Capacity | Density | Conductivity |
| (° C.) | (mm²/s) | (J/kg-K) | (g/cm³) | (W/m-K) |

Invention Alloy 7

| | | | | | |
|---|---|---|---|---|---|
| 50 | 7.691 | 0.506 | 7.92 | 30.8 | (56.1%) |
| 100 | 7.654 | 0.511 | 7.9 | 30.9 | (37.1%) |
| 150 | 7.619 | 0.521 | 7.89 | 31.3 | (30.2%) |
| 200 | 7.559 | 0.539 | 7.87 | 32.1 | (28.2%) |
| 250 | 7.474 | 0.560 | 7.85 | 32.9 | (27.6%) |
| 300 | 7.298 | 0.582 | 7.84 | 33.3 | (26.3%) |
| 350 | 7.085 | 0.606 | 7.82 | 33.6 | (23.9%) |
| 400 | 6.809 | 0.634 | 7.8 | 33.6 | (22.3%) |
| 450 | 6.546 | 0.664 | 7.78 | 33.8 | (21.0%) |
| 500 | 6.207 | 0.708 | 7.77 | 34.2 | (25.9% |
| 550 | 5.81 | 0.752 | 7.75 | 33.9 | (18.3%) |
| 600 | 5.376 | 0.810 | 7.73 | 33.7 | (16.0%) |

M300

| | | | | |
|---|---|---|---|---|
| 50 | 5.441 | 0.446 | 8.14 | 19.7 |
| 100 | 5.62 | 0.493 | 8.13 | 22.5 |
| 150 | 5.777 | 0.514 | 8.11 | 24.1 |
| 200 | 5.933 | 0.521 | 8.1 | 25.0 |
| 250 | 6.048 | 0.527 | 8.08 | 25.8 |
| 300 | 6.113 | 0.535 | 8.06 | 26.4 |
| 350 | 6.139 | 0.549 | 8.04 | 27.1 |
| 400 | 6.124 | 0.561 | 8.01 | 27.5 |
| 450 | 6.072 | 0.577 | 7.98 | 27.9 |
| 500 | 5.973 | 0.591 | 7.69 | 27.1 |
| 550 | 5.843 | 0.616 | 7.96 | 28.7 |
| 600 | 5.651 | 0.646 | 7.95 | 29.0 |

H13

| | | | | |
|---|---|---|---|---|
| 50 | 6.482 | 0.459 | 7.77 | 23.1 |
| 100 | 6.519 | 0.488 | 7.75 | 24.7 |
| 150 | 6.516 | 0.508 | 7.74 | 25.6 |
| 200 | 6.483 | 0.526 | 7.72 | 26.4 |
| 250 | 6.408 | 0.545 | 7.71 | 26.9 |
| 300 | 6.291 | 0.564 | 7.69 | 27.3 |
| 350 | 6.136 | 0.586 | 7.68 | 27.6 |
| 400 | 5.932 | 0.612 | 7.66 | 27.8 |
| 450 | 5.712 | 0.638 | 7.65 | 27.9 |
| 500 | 5.443 | 0.675 | 7.63 | 28.0 |
| 550 | 5.127 | 0.720 | 7.62 | 28.1 |
| 600 | 4.759 | 0.773 | 7.60 | 28.0 |

A further benefit of the disclosed alloys is their relatively high Ae1 temperature compared to M300, as shown in Table 14. The Ae1 temperature of M300 is about 403° C. The surfaces of die steels exposed to molten aluminum typically exceed 400° C. during each cycle. A higher Ae1 temperature will reduce or eliminate the thermodynamic driving force for austenite reversion in service.

The austenite reversion factor (ARF) was developed for the current invention alloys and commercial maraging steels and is proportionally related to the stability of the austenite phase and the Ae1 temperature. A lower ARF means austenite is more stable at typical die-steel service temperatures and reversion to austenite is more likely. If the Ae1 temperature of the alloys is near that of the peak in-service temperature or below, significant phase transformation of the microstructure can occur in service, including austenite reversion, where the martensite microstructure transforms to austenite in-service. Austenite reversion can have detrimental effects on mechanical performance in many applications, including degraded thermal fatigue properties, poor dimensional stability, and softening of the microstructure. The ARF was derived to assess the relative propensity for austenite reversion among different alloys.

$$A R F = 102 - 5.8 {Ni}_{wt . \%} - 7.4 {Mn}_{wt . \%} - 0.9 {Cr}_{wt . \%} + 2. {Si}_{wt . \%} + 0.04 {Mo}_{wt . \%} - 1.1 {Cu}_{wt . \%} + 0.6 {Co}_{wt . \%} + 3.1 {Al}_{wt . \%} ;$$

TABLE 14
Ae1 temperature of the reference,
invented and commercial alloy M300

| | Ae1 | Austenite | |
|---|---|---|---|
| | Temperature | Content (vol. %) | Reversion |
| Alloy | (° C.) | at 500° C. | Factor |
| 1 (Ref.) | 771 | 0 (Below Ae1) | 87.9 |
| 2 | 728 | 0 (Below Ae1) | 87.6 |
| 3 | 720 | 0 (Below Ae1) | 86.3 |
| 4 | 742 | 0 (Below Ae1) | 87.7 |
| 5 | 718 | 0 (Below Ae1) | 86.2 |
| 6 | 721 | 0 (Below Ae1) | 86.5 |
| 7 | 712 | 0 (Below Ae1) | 86.4 |
| 8 | 692 | 0 (Below Ae1) | 85.5 |
| 9 | 707 | 0 (Below Ae1) | 86.4 |
| 10 | 702 | 0 (Below Ae1) | 86.9 |
| 11 | 700 | 0 (Below Ae1) | 85.5 |
| 12 | 701 | 0 (Below Ae1) | 84.7 |
| 13 | 702 | 0 (Below Ae1) | 85.2 |
| 14 (Ref.) | 674 | 0 (Below Ae1) | 81.4 |
| 15 (Ref.) | 652 | 0 (Below Ae1) | 87.3 |
| 16 | 601 | 0 (Below Ae1) | 78.1 |
| 17 | 687 | 0 (Below Ae1) | 83.7 |
| 18 | 689 | 0 (Below Ae1) | 84.1 |
| 19 | 585 | 0 (Below Ae1) | 75.3 |
| 20 (Ref.) | 868 | 0 (Below Ae1) | 96.0 |
| 21 | 687 | 0 (Below Ae1) | 82.1 |
| 22 | 693 | 0 (Below Ae1) | 83.2 |
| 23 | 683 | 0 (Below Ae1) | 80.3 |
| 24 | 671 | 0 (Below Ae1) | 82.3 |
| 25 | 660 | 0 (Below Ae1) | 82.2 |
| 26 | 674 | 0 (Below Ae1) | 83.0 |
| 27 | 657 | 0 (Below Ae1) | 82.1 |
| 28 | 675 | 0 (Below Ae1) | 83.3 |
| 29 | 669 | 0 (Below Ae1) | 81.5 |
| 30 | 670 | 0 (Below Ae1) | 84.1 |
| 31 | 669 | 0 (Below Ae1) | 81.8 |
| 32 | 694 | 0 (Below Ae1) | 84.0 |
| 33 | 689 | 0 (Below Ae1) | 84.5 |
| 34 | 714 | 0 (Below Ae1) | 84.6 |
| 35 | 671 | 0 (Below Ae1) | 83.0 |
| 36 | 628 | 0 (Below Ae1) | 80.9 |
| 37 | 699 | 0 (Below Ae1) | 85.8 |
| 38 | 586 | 0 (Below Ae1) | 79.6 |
| 39 | 585 | 0 (Below Ae1) | 79.7 |
| 40 | 580 | 0 (Below Ae1) | 81.3 |
| 41 | 408 | 3.9 | 73.3 |
| 42 | 578 | 0 (Below Ae1) | 81.2 |
| 43 | 595 | 0 (Below Ae1) | 78.5 |
| 44 | 628 | 0 (Below Ae1) | 83.2 |
| 45 | 635 | 0 (Below Ae1) | 83.2 |
| 46 | 405 | 2.3 | 69.7 |
| 47 | 690 | 0 (Below Ae1) | 84.0 |
| 48 | 404 | 4 | 74.2 |
| 49 | 410 | 0.8 | 65.5 |
| M300 | 404 | 36.4 | 1.3 |
| Mar50 Co- | 394 | 14.6 | 42.8 |
| Free | | | |
| Mar-60 | 430 | 21.8 | 36.4 |
| (ASTM/AISI | | | |
| 13Ni400) | | | |
| Nominal | | | |
| TS 700 | 752 | 0 (Below Ae1) | 92.0 |

High temperature austenite stability factor: This formula is a relationship between the alloy chemistry and magnitude of the temperature range over which austenite is stable at high temperatures. A relatively large austenitization window is needed to enable austenitization of the material, thereby enabling martensite to form on quenching. A martensitic microstructure is desirable to facilitate more effective age hardening and to promote toughness.

$$H T A S F = 12 {Ni}_{wt . \%} + 10.2 {Mn}_{wt . \%} + 320 {C}_{wt . \%} - 0.4 {( {Cr}_{wt . \%} )}^{2} + 3.2 {Cr}_{wt . \%} - 5.7 {Si}_{wt . \%} - 9.4 {Mo}_{wt . \%} + 5.7 {Cu}_{wt . \%} - 13 {Ti}_{wt . \%} - 14.8 {Nb}_{wt . \%} - 1.2 {W}_{wt . \%} + 3.7 {Co}_{wt . \%} - 29.3 {Al}_{wt . \%} - 97.3 {V}_{wt . \%} - 0.46$$

The printable steels provided herein have at least the following benefits: 1) High strength in the age hardened condition; 2) Significantly higher thermal diffusivity relative to other die steels currently available in the critical range of temperature from 200-300° C., such as H13 and M300, which can improve process efficiency by reducing cycle times in die-casting and hot stamping operations while also improving die longevity; 3) Very low C content for improved printability in large structures; and 4) Designed for extended use at high temperature without phase transformation or austenite reversion by alloy design to ensure a relatively high Ae1 temperature; 5) reduced rate of softening during long term thermal exposure at 550 C relative to H13.

The performance factors HTASF, ARF, SF, HTF, NICOTIF are listed and compared in Table 15. All invention alloys meet the performance criteria −15≤HTASF≤40; 50≤ARF≤100; 23≤SF≤50; 4.9≤HTF≤9; and 0≤NiCoTiF≤10.

TABLE 15
Performance factors for invention alloys
and select commercial steels.

| Alloy | | | | | Ni + Ti + |
|---|---|---|---|---|---|
| Designation | HTASF | ARF | SF | HTF | Co |
| 2 | −1.8 | 87.6 | 23.7 | 7.9 | 1.6 |
| 3 | −0.01 | 86.3 | 31.3 | 7.8 | 1.6 |
| 4 | −7.7 | 87.7 | 39.9 | 7.4 | 1.6 |
| 5 | −1.2 | 86.2 | 32.4 | 7.7 | 1.7 |
| 6 | −10.1 | 86.5 | 37.2 | 7.7 | 1.6 |
| 7 | 1.7 | 86.4 | 40.3 | 7.4 | 1.8 |
| 8 | −3.0 | 85.5 | 39.6 | 7.3 | 2.0 |
| 9 | −0.4 | 86.4 | 40.0 | 7.6 | 1.9 |
| 10 | 10.3 | 86.9 | 37.8 | 7.5 | 1.8 |
| 11 | 4.5 | 85.5 | 31.9 | 7.9 | 1.8 |
| 12 | 7.5 | 84.7 | 34.8 | 7.7 | 1.8 |
| 13 | 4.8 | 85.2 | 33.5 | 7.9 | 1.8 |
| 16 | 26.0 | 78.1 | 30.9 | 7.7 | 5.6 |
| 17 | −4.1 | 83.7 | 32.2 | 7.7 | 2.4 |
| 18 | −7.6 | 84.1 | 29.9 | 7.7 | 2.4 |
| 19 | 6.8 | 75.3 | 44.8 | 6.1 | 3.1 |
| 21 | 8.9 | 82.1 | 30.9 | 7.1 | 2.3 |
| 22 | 13.1 | 83.2 | 29.6 | 7.3 | 1.8 |
| 23 | 15.0 | 80.3 | 37.3 | 6.6 | 2.5 |
| 24 | 12.4 | 82.3 | 37.8 | 6.7 | 2.6 |
| 25 | 8.3 | 82.2 | 41.6 | 6.6 | 2.2 |
| 26 | 7.9 | 83.0 | 41.7 | 6.6 | 2.1 |
| 27 | 8.5 | 82.1 | 41.4 | 6.6 | 2.2 |
| 28 | 9.0 | 83.3 | 38.0 | 6.9 | 2.0 |
| 29 | 13.7 | 81.5 | 26.9 | 7.3 | 2.1 |
| 30 | 2.4 | 84.1 | 41.6 | 7.2 | 2.2 |
| 31 | 11.8 | 81.8 | 33.9 | 7.0 | 2.1 |
| 32 | 6.1 | 84.0 | 44.3 | 6.5 | 2.1 |
| 33 | 0.5 | 84.5 | 44.1 | 6.4 | 2.2 |
| 34 | 5.8 | 84.6 | 45.0 | 6.2 | 2.2 |
| 35 | 6.6 | 83.0 | 42.7 | 6.6 | 2.2 |
| 36 | 5.9 | 80.9 | 47.8 | 6.3 | 2.5 |
| 37 | 26.0 | 85.8 | 44.7 | 6.5 | 7.1 |
| 38 | 9.9 | 79.6 | 44.4 | 6.3 | 3.0 |
| 39 | 16.3 | 79.6 | 46.3 | 6.3 | 3.0 |
| 40 | 1.3 | 81.3 | 48.5 | 6.2 | 3.0 |
| 41 | 23.1 | 73.3 | 42.7 | 6.0 | 4.1 |
| 42 | −0.5 | 81.2 | 44.0 | 6.4 | 1.9 |
| 43 | 1.8 | 78.5 | 47.8 | 5.3 | 2.9 |
| 44 | 11.6 | 83.2 | 39.9 | 6.8 | 2.2 |
| 45 | 12.6 | 83.2 | 45.3 | 6.7 | 2.3 |
| 46 | 34.1 | 69.7 | 43.8 | 5.0 | 4.2 |
| 47 | 7.7 | 84.0 | 39.5 | 6.9 | 1.9 |
| 48 | 17.7 | 74.2 | 35.5 | 6.1 | 4.0 |
| 1 (Ref) | −11.7 | 87.9 | 14.8 | 7.7 | 2.1 |
| 14 (Ref) | 31.5 | 81.4 | 18.0 | 8.1 | 5.3 |
| 15 (Ref) | 25.3 | 87.3 | 33.9 | 7.2 | 14.3 |
| 20 (Ref) | 20.6 | 96.0 | 36.9 | 8.8 | 0.0 |
| 49 (Ref) | 15.5 | 65.5 | 55.2 | 3.4 | 4.1 |
| H13 | 26.2 | 95.7 | 50.5 | 7.5 | 0.2 |
| M300 | 203.1 | 1.3 | 50.8 | 6.1 | 28.5 |
| Mar50 Co-Free | 71.8 | 42.8 | 51.0 | 5.1 | 10.5 |
| Mar-60 | 114.4 | 36.4 | 59.9 | 5.2 | 28.2 |
| (ASTM/ AISI | | | | | |
| 13Ni400) | | | | | |
| Stellar TS700 | 8.1 | 92.0 | 51.5 | 5.7 | 13.8 |

The printable steels provided herein are suitable, but not limited, to the following applications. Printed dies for aluminum and magnesium-die casting and hot stamping operations. Pistons of internal combustion engines. Heat exchanger components. Any applications requiring complex geometries where both high strength and thermal conductivity are needed, including pistons or components of heat exchangers or die inserts.

The invention as shown in the drawings and described in detail herein disclose arrangements of elements of particular construction and configuration for illustrating preferred embodiments of structure and method of operation of the present invention. It is to be understood however, that elements of different construction and configuration and other arrangements thereof, other than those illustrated and described may be employed in accordance with the spirit of the invention, and such changes, alternations and modifications as would occur to those skilled in the art are considered to be within the scope of this invention as broadly defined in the appended claims. In addition, it is to be understood that the phraseology and terminology employed herein are for the purpose of description and should not be regarded as limiting.

We claim:

1. A printable steel alloy, comprising, in weight percent based on the total weight of the alloy:
1.75 to 5 Cu;
1.9 to 8 Mo;
0 to 4.25 Ni;
0 to 1 Mn;
0 to 0.1 C;
0 to 6 Cr;
0 to 2.1 Si;
0 to 1.6 Ti;
0 to 1 Nb;
0 to 7 W;
0 to 6 Co;
0 to 1 Al;
0 to 0.1 N;
0 to 0.04 S;
0 to 0.005 B;
0 to 0.1 V; and,
balance Fe.

2. The printable steel alloy of claim 1, wherein the strength factor (SF) is defined by
$$S F = - 1 5.1 - 0.39 {Ni}_{wt . \%} + 0.95 {Mn}_{wt . \%} + 75.2 {C}_{wt . \%} + 2.29 {Cr}_{wt . \%} + 11.6 {Si}_{wt . \%} + 5.93 {Mo}_{wt . \%} + 2.91 {Cu}_{wt . \%} + 10.3 {Ti}_{wt . \%} + 26.8 {Nb}_{wt . \%} + 2.54 {W}_{wt . \%} + 0.78 {Co}_{wt . \%} + 9. {Al}_{wt . \%} + 0.4 ( {Mo}_{wt . \%} - 4.58 ) ( {Mo}_{wt . \%} - 4.58 ) - 2.56 ( {Si}_{wt . \%} - 0.65 ) ( {Si}_{wt . \%} - 0.65 ) - 37.1 ( {Nb}_{wt . \%} - 0.09 ) ( {Nb}_{wt . \%} - 0.09 ) + 2.67 ( {Mo}_{wt . \%} - 4.58 ) ( {Si}_{wt . \%} - 0.65 ) + 4. ( {Ni}_{wt . \%} - 2.95 ) ( {Ti}_{wt . \%} - 0.12 ) + 0.0 \; 08 ( {Ni}_{wt . \%} - 2.95 ) ( {Mo}_{wt . \%} - 4.58 ) ;$$
$$and wherein 23 \leq S F \leq 50.$$

3. The printable steel alloy of claim 1, wherein the austenite reversion factor (ARF) is defined by
$$A R F = 102 - 5.8 {Ni}_{wt . \%} - 7.4 {Mn}_{wt . \%} - 0.9 {Cr}_{wt . \%} + 2. {Si}_{wt . \%} + 0.04 {Mo}_{wt . \%} - 1.1 {Cu}_{wt . \%} + 0.6 {Co}_{wt . \%} + 3.1 {Al}_{wt . \%} ;$$
$$and wherein 50 \leq A R F \leq 100.$$

4. The printable steel alloy of claim 3, wherein 60≤ARF≤100.

5. The printable steel alloy of claim 1, wherein the heat transfer factor (HTF) is defined as
$$H T F = 7.1 - 0.5 {Mn}_{wt . \%} - 0.32 {Cr}_{wt . \%} - 0.43 {Si}_{wt . \%} - 0.15 ( {Mo}_{wt . \%} + {W}_{wt . \%} + {Nb}_{wt . \%} ) - 0.03 {Co}_{wt . \%} - 0.43 {Al}_{wt . \%} + 3.09 Exp ( - 0 \text{.28} {Ni}_{wt . \%} )$$
$$and wherein 4.9 \leq H T F \leq 9.$$

6. The printable steel alloy of claim 1, wherein the high temperature austenite stability factor (HTASF) is defined as
$$HTASF = 12 {Ni}_{wt . \%} + 10.2 {Mn}_{wt . \%} + 320 {C}_{wt . \%} - 0.4 {( {Cr}_{wt . \%} )}^{2} + 3.2 {Cr}_{wt . \%} - 5.7 {Si}_{wt . \%} - 9.4 {Mo}_{wt . \%} + 5.7 {Cu}_{wt . \%} - 13 {Ti}_{wt . \%} - 14.8 {Nb}_{wt . \%} - 1.2 {W}_{wt . \%} + 3.7 {Co}_{wt . \%} - 29.3 {Al}_{wt . \%} - 97.3 {V}_{wt . \%} - 0.46 ;$$
$$and wherein - 15 \leq HTASF \leq 40.$$

7. The printable steel alloy of claim 1, wherein the NiCoTi factor (NiCoTiF) is defined as
$$NiCoTiF = {Ni}_{wt . \%} + {Co}_{wt . \%} + {Ti}_{wt . \%} ;$$
$$and wherein 0 \leq NiCoTiF \leq 10.$$

8. The printable steel alloy of claim 1, wherein:
a strength factor (SF) is defined by the equation:
$$SF = - 15.1 - 0.39 {Ni}_{wt . \%} + 0.95 {Mn}_{wt . \%} + 75.2 {C}_{wt . \%} + 2.29 {Cr}_{wt . \%} + 11.6 {Si}_{wt . \%} + 5.93 {Mo}_{wt . \%} + 2.91 {Cu}_{wt . \%} + 10.3 {Ti}_{wt . \%} + 26.8 {Nb}_{wt . \%} + 2.54 {W}_{wt . \%} + 0.78 {Co}_{wt . \%} + 9. {Al}_{wt . \%} + 0.48 ( {Mo}_{wt . \%} - 4.58 ) ( {Mo}_{wt . \%} - 4.58 ) - 2.56 ( {Si}_{wt . \%} - 0.65 ) ( {Si}_{wt . \%} - 0.65 ) - 37.1 ( {Nb}_{wt . \%} - 0.09 ) ( {Nb}_{wt . \%} - 0.09 ) + 2.67 ( {Mo}_{wt . \%} - 4.58 ) ( {Si}_{wt . \%} - 0.65 ) + 4. ( {Ni}_{wt . \%} - 2.95 ) ( {Ti}_{wt . \%} - 0.12 ) + 0.008 ( {Ni}_{wt . \%} - 2.95 ) ( {Mo}_{wt . \%} - 4.58 ) ;$$
$$and wherein 23 \leq SF \leq 50 ;$$
an austenite reversion factor (ARF) is defined by the equation:
$$ARF = 102 - 5.8 {Ni}_{wt . \%} - 7.4 {Mn}_{wt . \%} - 0.9 {Cr}_{wt . \%} + 2. {Si}_{wt . \%} + 0.04 {Mo}_{wt . \%} + 1.1 {Cu}_{wt . \%} + 0.6 {Co}_{wt . \%} + 3.1 {Al}_{wt . \%} ;$$
$$and wherein 50 \leq ARF \leq 100 ;$$
a heat transfer factor (HTF) is defined by the equation:
$$HTF = 7.1 - 0.5 {Mn}_{wt . \%} - 0.32 {Cr}_{wt . \%} - 0.43 {Si}_{wt . \%} - 0.15 ( {Mo}_{wt . \%} + {W}_{wt . \%} + {Nb}_{wt . \%} ) - 0.03 {Co}_{wt . \%} - 0.43 {Al}_{wt . \%} + 3.09 Exp ( - 0.28 {Ni}_{wt . \%} ) ;$$
$$and wherein 4.9 \leq HTF \leq 9 ;$$
a high temperature austenite stability factor (HTASF) is defined by the equation:
$$HTASF = 12 {Ni}_{wt . \%} + 10.2 {Mn}_{wt . \%} + 320 {C}_{wt . \%} - 0.4 {( {Cr}_{wt . \%} )}^{2} + 3.2 {Cr}_{wt . \%} - 5.7 {Si}_{wt . \%} - 9.4 {Mo}_{wt . \%} + 5.7 {Cu}_{wt . \%} - 13 {Ti}_{wt . \%} - 14.8 {Nb}_{wt . \%} - 1.2 {W}_{wt . \%} + 3.7 {Co}_{wt . \%} - 29.3 {Al}_{wt . \%} - 97.3 {V}_{wt . \%} - 0.46 ;$$
$$wherein - 15 \leq HTASF \leq 40 ; and ,$$
$$a NiCoTi factor ( NiCoTiF ) is defined as :$$
$$NiCoTiF = {Ni}_{wt . \%} + {Co}_{wt . \%} + {Ti}_{wt . \%} ;$$
$$and wherein 0 \leq NiCoTiF \leq 10.$$

9. The printable steel alloy of claim 1, wherein the average hardness in the as-printed condition, solution treated condition, and/or as-printed then solution treated condition is equal to or less than 37 HRC.

10. The printable steel alloy of claim 1, wherein the room temperature ultimate tensile strength is equal to or greater than 1200 MPa and the average room temperature hardness is equal or greater than 39 HRC after solution treating and then aging at 550° C. for 4 h.

11. The printable steel alloy of claim 1, wherein the ultimate tensile strength at 550° C. is equal to or greater than 700 MPa after solution treating and then aging at 550° C. for 4 h.

12. The printable steel alloy of claim 1, wherein the room temperature hardness of the alloy is equal to or greater than 32 HRC after the alloy is solution treated, aged, and subsequently long term thermally soaked at 550° C. for 500 h.

13. The printable steel alloy of claim 1, wherein the thermal diffusivity is greater than or equal to 6 mm²/s in the temperature range including 100° C. up to and including 300° C., and greater than 4.5 mm²/s from temperatures greater than 300° C. up to and including 500° C.

14. The printable steel alloy of claim 1, wherein the Ae1 temperature of the steel is greater than or equal to 550° C.

15. The printable steel alloy of claim 1, wherein:
the average hardness in the as-printed condition, solution treated condition, and/or as-printed then solution treated condition is equal to or less than 37 HRC,
the room temperature ultimate tensile strength is equal to or greater than 1200 MPa and the room temperature average hardness is equal or greater than 39 HRC after solution treating and then aging at 550° C. for 4 h,
the ultimate tensile strength at 550° C. is equal to or greater than 700 MPa after solution treating and then aging at 550° C. for 4 h,
the room temperature hardness of the alloy is equal to or greater than 32 HRC after the alloy is solution treated, aged, and subsequently long term thermally soaked at 550° C. for 500 h,
the thermal diffusivity is greater than or equal to 6 mm²/s in the temperature range including 100° C. up to and including 300° C., and greater than 4.5 mm²/s from temperatures greater than 300° C. up to and including 500° C., and
the Ae1 temperature of the steel is greater than or equal to 550° C.

16. A method for printing an article with a steel alloy, comprising the steps of:
providing a steel alloy feedstock, the feedstock comprising, in weight percent based on the total weight of the alloy:
1.75 to 5 Cu;
1.9 to 8 Mo;
0 to 4.25 Ni;
0 to 1 Mn;
0 to 0.1 C;
0 to 6 Cr;
0 to 2.1 Si;
0 to 1.6 Ti;
0 to 1 Nb;
0 to 7 W;
0 to 6 Co;
0 to 1 Al;
0 to 0.1 N;
0 to 0.04 S;
0 to 0.005 B;
0 to 0.1 V; and,
balance Fe;
where the feedstock is in powder or wire form, and,
printing the article with the feedstock.

17. The method of claim 16, wherein the strength factor (SF) is defined by
$$SF = - 15.1 - 0.39 {Ni}_{wt . \%} + 0.95 {Mn}_{wt . \%} + 75.2 {C}_{wt . \%} + 2.29 {Cr}_{wt . \%} + 11.6 {Si}_{wt . \%} + 5.93 {Mo}_{wt . \%} + 2.91 {Cu}_{wt . \%} + 10.3 {Ti}_{wt . \%} + 26.8 {Nb}_{wt . \%} + 2.54 {W}_{wt . \%} + 0.78 {Co}_{wt . \%} + 9. {Al}_{wt . \%} + 0.48 ( {Mo}_{wt . \%} - 4.58 ) ( {Mo}_{wt . \%} - 4.58 ) - 2.56 ( {Si}_{wt . \%} - 0.65 ) ( {Si}_{wt . \%} - 0.65 ) - 37.1 ( {Nb}_{wt . \%} - 0.09 ) ( {Nb}_{wt . \%} - 0.09 ) + 2.67 ( {Mo}_{wt . \%} - 4.58 ) ( {Si}_{wt . \%} - 0.65 ) + 4. ( {Ni}_{wt . \%} - 2.95 ) ( {Ti}_{wt . \%} - 0.12 ) + 0.008 ( {Ni}_{wt . \%} - 2.95 ) ( {Mo}_{wt . \%} - 4.58 ) ;$$
$$and wherein 23 \leq SF \leq 50.$$

18. The method of claim 16, wherein the austenite reversion factor (ARF) is defined by
$$ARF = 102 - 5.8 {Ni}_{wt . \%} - 7.4 {Mn}_{wt . \%} - 0.9 {Cr}_{wt . \%} + 2. {Si}_{wt . \%} + 0.04 {Mo}_{wt . \%} + 1.1 {Cu}_{wt . \%} + 0.6 {Co}_{wt . \%} + 3.1 {Al}_{wt . \%} ;$$
$$and wherein 50 \leq ARF \leq 100.$$

19. The method of claim 18, wherein 60≤ARF≤100.

20. The method of claim 16, wherein the heat transfer factor (HTF) is defined as:
$$HTF = 7.1 - 0.5 {Mn}_{wt . \%} - 0.32 {Cr}_{wt . \%} - 0.43 {Si}_{wt . \%} - 0.15 ( {Mo}_{wt . \%} + {W}_{wt . \%} + {Nb}_{wt . \%} ) - 0.03 {Co}_{wt . \%} - 0.43 {Al}_{wt . \%} + 3.09 Exp ( - 0.28 {Ni}_{wt . \%} )$$
$$and wherein 4.9 \leq HTF \leq 9.$$

21. The method of claim 16, wherein the high temperature austenite stability factor (HTASF) is defined as:
$$HTASF = 12 {Ni}_{wt . \%} + 10.2 {Mn}_{wt . \%} + 320 {C}_{wt . \%} - 0.4 {( {Cr}_{wt . \%} )}^{2} + 3.2 {Cr}_{wt . \%} - 5.7 {Si}_{wt . \%} - 9.4 {Mo}_{wt . \%} + 5.7 {Cu}_{wt . \%} - 13 {Ti}_{wt . \%} - 14.8 {Nb}_{wt . \%} - 1.2 {W}_{wt . \%} + 3.7 {Co}_{wt . \%} - 29.3 {Al}_{wt . \%} - 97.3 {V}_{wt . \%} - 0.46 ;$$
$$and wherein - 15 \leq HTASF \leq 40.$$

22. The method of claim 16, wherein the NiCoTi factor (NiCoTiF) is defined as
$$NiCoTiF = {Ni}_{wt . \%} + {Co}_{wt . \%} + {Ti}_{wt . \%} ;$$
$$and wherein 0 \leq NiCoTiF \leq 10.$$

23. The method of claim 16, wherein:
a strength factor (SF) is defined by the equation:
$$SF = - 15.1 - 0.39 {Ni}_{wt . \%} + 0.95 {Mn}_{wt . \%} + 75.2 {C}_{wt . \%} + 2.29 {Cr}_{wt . \%} + 11.6 {Si}_{wt . \%} + 5.93 {Mo}_{wt . \%} + 2.91 {Cu}_{wt . \%} + 10.3 {Ti}_{wt . \%} + 26.8 {Nb}_{wt . \%} + 2.54 {W}_{wt . \%} + 0.78 {Co}_{wt . \%} + 9. {Al}_{wt . \%} + 0.48 ( {Mo}_{wt . \%} - 4.58 ) ( {Mo}_{wt . \%} - 4.58 ) - 2.56 ( {Si}_{wt . \%} - 0.65 ) ( {Si}_{wt . \%} - 0.65 ) - 37.1 ( {Nb}_{wt . \%} - 0.09 ) ( {Nb}_{wt . \%} - 0.09 ) + 2.67 ( {Mo}_{wt . \%} - 4.58 ) ( {Si}_{wt . \%} - 0.65 ) + 4. ( {Ni}_{wt . \%} - 2.95 ) ( {Ti}_{wt . \%} - 0.12 ) + 0.008 ( {Ni}_{wt . \%} - 2.95 ) ( {Mo}_{wt . \%} - 4.58 ) ;$$
$$and wherein 23 \leq SF \leq 50 ;$$
an austenite reversion factor (ARF) is defined by the equation:
$$ARF = 102 - 5.8 {Ni}_{wt . \%} - 7.4 {Mn}_{wt . \%} - 0.9 {Cr}_{wt . \%} + 2. {Si}_{wt . \%} + 0.04 {Mo}_{wt . \%} + 1.1 {Cu}_{wt . \%} + 0.6 {Co}_{wt . \%} + 3.1 {Al}_{wt . \%} ;$$
$$and wherein 50 \leq ARF \leq 100 ;$$
a heat transfer factor (HTF) is defined by the equation:
$$HTF = 7.1 - 0.5 {Mn}_{wt . \%} - 0.32 {Cr}_{wt . \%} - 0.43 {Si}_{wt . \%} - 0.15 ( {Mo}_{wt . \%} + {W}_{wt . \%} + {Nb}_{wt . \%} ) - 0.03 {Co}_{wt . \%} - 0.43 {Al}_{wt . \%} + 3.09 Exp ( - 0.28 {Ni}_{wt . \%} ) ;$$
$$and wherein 4.9 \leq HTF \leq 9 ;$$
a high temperature austenite stability factor (HTASF) is defined by the equation:
$$HTASF = 12 {Ni}_{wt . \%} + 10.2 {Mn}_{wt . \%} + 320 {C}_{wt . \%} - 0.4 {( {Cr}_{wt . \%} )}^{2} + 3.2 {Cr}_{wt . \%} - 5.7 {Si}_{wt . \%} - 9.4 {Mo}_{wt . \%} + 5.7 {Cu}_{wt . \%} - 13 {Ti}_{wt . \%} - 14.8 {Nb}_{wt . \%} - 1.2 {W}_{wt . \%} + 3.7 {Co}_{wt . \%} - 29.3 {Al}_{wt . \%} - 97.3 {V}_{wt . \%} - 0.46 ,$$
$$and wherein - 15 \leq HTASF \leq 40 , and$$
$$a NiCoTi factor ( NiCoTiF ) is defined as$$
$$NiCoTiF = {Ni}_{wt . \%} + {Co}_{wt . \%} + {Ti}_{wt . \%} ;$$
$$and wherein 0 \leq NiCoTiF \leq 10.$$

24. The method of claim 23, further comprising a solution treatment step, a quenching step, and a subsequent age-hardening step, the solution treatment step being conducted at temperatures from 950 to 1065° C. for 1 h, followed by quenching in water, air, forced air, oil, gas, or other suitable quenching medium, such that the as-quenched hardness is equal to or less than 37 HRC.

25. The method of claim 23, where the article is printed by laser powder bed fusion additive manufacturing with a volumetric energy density (VED) ranging from 90.28 J/mm³ to 150 J/mm³, layer thickness of 0.03 mm, a build plate temperature of nominally 100° C., and power (P), scan velocity (v), hatch spacing (h), and power to velocity ratio (P/v) in accordance with the ranges below in order to achieve porosity levels equal to 0.1% or less:
at a VED of 90.28 J/mm³: 135.4 W≤P≤292.5 W, 500 mm/s≤v≤900 mm/s, 0.22 W s/mm≤P/v≤0.33 W s/mm, and 0.08 mm≤h≤0.12 mm;
at a VED of 97.22 J/mm³: 145.8 W≤P≤315 W, 500 mm/s≤v≤900 mm/s, 0.23 W s/mm≤P/v≤0.35 W s/mm, and 0.08 mm≤h≤0.12 mm;
at a VED of 125 J/mm³: 157.5 W≤P≤337.5 W, 700 mm/s≤v≤900 mm/s, 0.225 W s/mm≤P/v≤0.38 W s/mm, and 0.06 mm≤h≤0.10 mm; or,
at a VED of 150 J/mm³: 189 W≤P≤360 W, 700 mm/s≤v≤900 mm/s, 0.27 W s/mm≤P/v≤0.45 W s/mm, and 0.06 mm≤h≤0.10 mm.

26. The method of claim 25, further comprising a solution treatment step, a quenching step, and a subsequent age-hardening step, the solution treatment step being conducted at temperatures from 950 to 1065° C., followed by quenching in water, air, forced air, oil, gas, or other suitable quenching medium, such that the as-quenched hardness is equal to or less than 37 HRC after solution treatment and quenching.

27. The method of claim 16, wherein the printed article is a die component.

28. A die component, comprising a printed steel alloy, the printed steel alloy comprising, in weight percent based on the total weight of the alloy:
1.75 to 5 Cu;
1.9 to 8 Mo;
0 to 4.25 Ni;
0 to 1 Mn;
0 to 0.1 C;
0 to 6 Cr;
0 to 2.1 Si;
0 to 1.6 Ti;
0 to 1 Nb;
0 to 7 W;
0 to 6 Co;
0 to 0.2 Al;
0 to 0.1 N;
0 to 0.04 S;
0 to 0.005 B;
0 to 0.1 V; and,
balance Fe.

29. The method of claim 26, wherein the printed article that is solution treated, quenched, and age-hardened is a die or die component.
